(19) United States
(12) Patent Application Publication
(10) Pub. No.: US 2009/0155553 A1
(43) Pub. Date: Jun. 18, 2009

(54) Method of manufacturing surface metal film material, surface metal film material, method of manufacturing patterned metal material, patterned metal material, and polymer layer-forming composition

(75) Inventor: Hideo Nagasaki, Ashigarakami-gun (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/314,271

(22) Filed: Dec. 8, 2008

(30) Foreign Application Priority Data
Dec. 14, 2007 (JP) 2007-323155

(51) Int. Cl. B32B 3/10; B05D 3/00; C25D 5/34; C08F 18/22; B32B 27/06

(52) U.S. Cl. 428/209; 427/304; 427/209; 205/80; 428/457; 526/312

(57) ABSTRACT

The present invention provides a method of manufacturing capable of readily obtaining a surface metal film material that has excellent adhesiveness of a metal film, reduced variability of adhesion due to humidity changes and excellent heat resistance and flexibility, and a method of manufacturing capable of readily obtaining a patterned metal material excellent in insulation reliability of a region where a patterned metal is not formed, and excellent in heat resistance and flexibility.

A method of manufacturing a surface metal film material includes: forming a polymer layer including a polymer that has a cyano group and that chemically bonds directly with a polyimide film, on the polyimide film; imparting a plating catalyst or a precursor thereof to the polymer layer; and performing a plating process on the plating catalyst or the precursor thereof, and a method of manufacturing a patterned metal material including etching a pattern in a plating film of a surface metal film material obtained according to the method of manufacturing a surface metal film material.

### CROSS-REFERENCE TO RELATED APPLICATION

This application claims priority under 35 USC 119 from Japanese Patent Application No.2007-323155, the disclosure of which is incorporated by reference herein.

### BACKGROUND OF THE INVENTION

### Field of the Invention

The present invention relates to a method of manufacturing a surface metal film material, a surface metal film material, a method of manufacturing a patterned metal material, a patterned metal material, and a polymer layer-forming composition.

Conventionally, a metal wiring board obtained by forming a patterned metal wiring on a surface of an insulating substrate has been widely used in electronic components and semiconductor devices.

As a method of manufacturing such a patterned metal material, a “subtractive process” is mainly used. In the subtractive process, a photosensitive layer photosensitive to irradiation with an active ray is disposed on a metal film formed on a substrate surface, the photosensitive layer is exposed imagewise and developed to form a resist image, then a metal film is etched to form a metal pattern, and finally the resist is peeled off.

In the patterned metal obtained according to the above method, adhesiveness is generated between the substrate and metal film due to an anchoring effect generated by disposing irregularities on the metal surface. However, owing to the irregularities of a substrate interface portion of the resulting patterned metal, there is a problem in that high frequency characteristics are deteriorated when the patterned metal is used as a metal wiring. Furthermore, in order to render the metal surface irregular, a strong acid such as chromic acid is necessarily used to process the substrate surface; accordingly, there is a problem in that a complicated process is necessary to obtain a patterned metal excellent in the adhesiveness between a metal film and a substrate.

In order to overcome the above problem, a method has been proposed in which a surface treatment is applied to improve the adhesiveness between the substrate and metal film without roughening the substrate surface, in which a plasma treatment is applied on a substrate surface, a polymerization initiating group is introduced in the substrate surface, and monomers are polymerized from the polymerization initiating group, thereby forming a surface graft polymer having a polar group on the substrate surface (see Advanced Materials, 2000 (20), pp. 1481 to 1494). However, according to this method, since the graft polymer has a polar group, moisture is readily absorbed or desorbed due to temperature or humidity variation, resulting in a problem in that a resulting metal film or substrate is deformed.

Furthermore, when the patterned metal obtained by this method is used as a wiring of a metal wiring board, since the graft polymer having a polar group remains at a substrate interface portion and tends to retain moisture or ions, there are concerns as to whether satisfactory levels of temperature and humidity dependencies, migration resistance and shape deformation can be obtained. In particular, when the patterned metal is applied to a micro-wiring such as a printed wiring board, high insulating properties are necessary between wires (patterned metals); accordingly, at present, improvements in the insulation reliability between the wires is demanded.

In particular, in a flexible wiring board where a substrate made of a polyimide film is used, since it is folded, improvements in the adhesiveness between the substrate and the metal film are demanded, in addition to improvements in the insulation reliability between wires.

### SUMMARY OF THE INVENTION

The present invention has been made in view of the above-mentioned disadvantages of the conventional technologies, and aims to accomplish the following. That is, the invention according to a first aspect of the invention provides a surface metal film material that is excellent in the adhesiveness of a metal film, reduced variability of the adhesion due to temperature variation and excellent heat resistance and flexibility, and a method of manufacturing a surface metal film material, which enables to obtain the surface metal film material according to a simplistic process.

Furthermore, the invention according to a second aspect of the invention provides a patterned metal material that is excellent in the insulation reliability of a region where a patterned metal is not formed and excellent in the heat resistance and flexibility, and a method of manufacturing a patterned metal material, which enables to obtain the patterned metal material according to a simplistic process.

Still furthermore, the invention according to a third aspect of the invention provides a polymer layer-forming composition capable of forming a polymer layer that is low in the water-absorbing property, high in the hydrophobicity and excellent in the adsorptive property to a plating catalyst or a precursor thereof.

### DETAILED DESCRIPTION

The inventors found, after studying hard the problems, that the objects to solve the problems may be achieved by means shown below.

A method of manufacturing a surface metal film material of the invention includes:

(a1) forming on a polyimide film a polymer layer comprising a polymer that has a cyano group and that chemically bonds directly with the polyimide film;

(a2) imparting a plating catalyst or a precursor thereof on the polymer layer; and

(a3) performing a plating process on the plating catalyst or the precursor thereof.

In the invention, the (al) step is preferably performed by chemically bonding a polymer having a cyano group and a polymerizable group directly on a polyimide film.

Furthermore, it is more preferable that a polymer having a cyano group and a polymerizable group is a copolymer containing a unit represented by Formula (1) shown below and a unit represented by Formula (2) shown below.

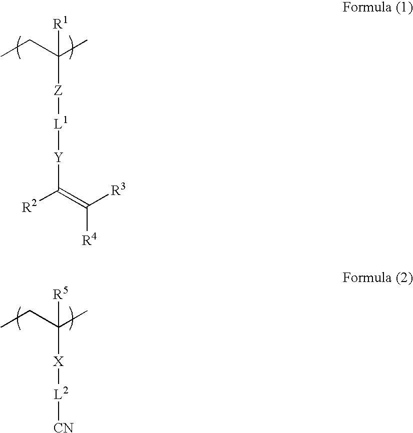

In the Formulae (1) and (2), R¹ through R⁵, respectively and independently, represents a hydrogen atom or a substituted or unsubstituted alkyl group, X, Y and Z, respectively and independently, represents a single bond or a substituted or unsubstituted divalent organic group, an ester group, an amide group or an ether group, and L¹ and L², respectively and independently, represents a substituted or unsubstituted divalent organic group.

In the invention, a weight average molecular weight of a polymer having a cyano group and a polymerizable group is preferably 20000 or more.

In a method of manufacturing a surface metal film material of the invention, in the (a3) step, electroless plating is preferably applied and, after the electroless plating, the electroplating is more preferably further performed.

Furthermore, a plating catalyst used in the (a2) step is preferably palladium.

In the method of manufacturing a surface metal film material of the invention, the (a1) step is preferably performed by forming a polymer layer comprising a polymer having a cyano group and chemically bonded directly with a polyimide film on both sides of the polyimide film.

In this case, each of the (a1) step, (a2) step and (a3) step is sequentially or simultaneously carried out on both surfaces of the polyimide film.

A surface metal film material of the invention is obtained by use of a method of manufacturing a surface metal film material of the invention.

A polymer layer-forming composition contains a polymer having a cyano group and a polymerizable group and a solvent capable of dissolving the polymer, and is used in a method of manufacturing a surface metal film material of the invention.

A method of manufacturing a patterned metal material of the invention includes (a4) etching a plating film of a surface metal film material obtained according to a method of manufacturing a surface metal film material of the invention in pattern.

That is, a method of manufacturing a patterned metal material of the invention performs, after the (a1), (a2) and (a3) steps in the method of manufacturing a surface metal film material are carried out, etching a resulting plating film in pattern [(a4) step].

A patterned metal material of the invention is obtained according to a method of manufacturing a patterned metal material of the invention.

Hereinafter, the present invention will be described in detail.

### <Method of Manufacturing Surface Metal Film Material, Method of Manufacturing Patterned Metal Material>

A method of manufacturing a substrate with a metal film of the present invention includes: (a1) forming on a polyimide film a polymer layer comprising a polymer having a cyano group and chemically bonded directly with the polyimide film; (a2) adding a plating catalyst or a precursor thereof to the polymer layer; and (a3) performing the plating to the plating catalyst or the precursor thereof.

A method of manufacturing a patterned metal material of the invention includes (a4) a step of etching and patterning a plating film of a surface metal film material obtained according to a method of manufacturing a surface metal film material of the invention.

That is, a method of manufacturing a patterned metal material carries out, after the (a1), (a2) and (a3) steps in the method of manufacturing a surface metal film material are carried out, a step of etching a resulting plating film in pattern [(a4) step].

In the method of manufacturing a surface metal film material of the invention and a method of manufacturing a patterned metal material, a polymer layer formed on a polyimide film is, while being a group capable of forming an interaction with a plating catalyst or a precursor thereof added in the (a2) step, low in the water absorbing property and high in the hydrophobicity. Furthermore, when, after a plating catalyst or the like is added to a polymer layer comprising a polymer bonded to a polyimide film, the plating is carried out therewith, a metal film excellent in the adhesiveness with the polymer layer is obtained.

From the points, a resulting surface metal film material has a metal film excellent in the adhesiveness with a polyimide film and a polymer layer does not change in response to the humidity change; accordingly, the adhesiveness changes less due to the humidity variation. The surface metal film material like this is applied to a method of manufacturing a patterned metal material described below and used as an electric wiring material. Furthermore, in addition to the above, the surface metal film material is used in an electromagnetic wave shielding film and a shielding material as well. In particular, the resulting surface metal film material has the flexibility and is used in various applications used by folding such as flexible wiring boards.

Furthermore, according to the method of manufacturing a patterned metal material, even when, in the (a4) step, a plating film formed over an entire surface of the polyimide film is etched in pattern to obtain a metal pattern and thereby a state where a polymer layer is exposed in an unformed region of the metal pattern is formed, the exposed portion does not absorb water and thereby the insulating properties are inhibited from deteriorating due to the water absorption. As the result, a patterned metal material formed according to a method of manufacturing the patterned metal material of the invention has the flexibility and is excellent in the insulation reliability in a region where a metal pattern is not formed.

In the beginning, the respective steps of (a1) through (a3) in a method of manufacturing a surface metal film material of the invention will be described.

[(a1) Step]

In a (a1) step in a method of manufacturing the invention of a surface metal film material, on a polyimide film, a polymer layer comprising a polymer having a cyano group and chemically bonded directly with the polyimide film is formed.

In the (a1) step, a polymer having a cyano group and a polymerizable group is preferably chemically bonded directly on a polyimide film.

In the invention, a polyimide film and a polymer constituting a polymer layer are necessary to form a direct chemical bond.

(Surface Graft)

The polymer layer is formed onto the surface of the polyimide film by means of generally-used so-called surface graft polymerization in the present invention. Graft polymerization is a method of preparing a graft polymer by adding an active species to a polymer compound chain and allowing it to polymerize with another monomer that initiates polymerization. In particular, when the polymer compound providing the active species is present on a solid surface, it is called surface graft polymerization.

Methods of the surface graft polymerization to be applied to the present invention include any known methods described in literature. Examples thereof include the photo-graft polymerization methods and plasma irradiation graft polymerization methods described in New Polymer Experimental Studies vol. 10 (Soc. Polymer Science Japan Ed., 1994, Kyoritsu Shuppan Co., Ltd., p. 135). In addition, examples thereof also include radiation irradiation graft polymerization methods of using y ray or electron beam described in Handbook of Absorption Technology (NTS., Takeuchi Ed., February 1999, p. 203 and 695).

Specific examples of the photo-graft polymerization methods include the methods described in JP-A Nos. 63-92658, 10-296895, and 11-119413.

In addition to these surface graft methods above, in order to form the polymer layer of the invention, a method of introducing a reactive functional group such as a trialkoxysilyl group, isocyanate group, amino group, hydroxyl group, or carboxyl group to a terminal of a polymer compound chain and connecting the functional group with the functional group present on the polyimide film surface by a coupling reaction is applicable.

Among these methods, from the viewpoint of generating more graft polymers, a photo-graft polymerization method is preferable, and a photo-graft polymerization method using UV light is particularly preferable to form the polymer layer.

[Polyimide Film]

In general, polyimide is a high molecule compound having a molecular structure such as thermally and chemically stable imide ring (heterocycle) or aromatic ring in a main chain and is excellent in the heat resistance, the mechanical strength, the electric insulating properties and the chemical resistance.

Accordingly, in the invention, the polyimide is formed in film to use as a polyimide film, and, thereby, excellent heat resistance and flexibility are imparted to a resulting surface metal film material.

The polyimide film in the invention has, in addition to the fundamental physical properties such as mentioned above, at least a function by which a surface thereof is capable of forming a state where a polymer having a cyano group is directly chemically bonded. Specifically, one obtained by imparting a functional group capable of directly bonding with a polymer having a cyano group or an active point for forming a state directly bonded with a polymer having a cyano group on a polyimide film surface, and one where a polyimide film per se has the polymerization initiating capability are preferably used.

Specific examples of the polyimide films used in the invention include preferably, without particularly restricting, Kapton H, Kapton E N and Kapton V (trade names, produced by Du Pont-Toray Co., Ltd., Eupilex-S (trade name, produced by Ube Industries. Ltd.) and Apical AH and Apical NPI (trade name, produced by Kaneka Corporation).

As the polyimide film in the invention, base materials containing polyimide having a polymerization initiating site in a skeleton, which are described in paragraph Nos. [0028] through

in JP-A No. 2005-281350, may be used as well.

When applications in semiconductor packages and polyimide films for various kinds of electric wirings are considered, a polyimide film used in the invention is preferably 500 nm or less in the surface irregularity, more preferably 100 nm or less, still more preferably 50 nm or less and most preferably 20 nm or less. As the surface irregularity of the polyimide film becomes smaller, when a resulting patterned metal material is applied in the wirings, the electric loss during high frequency transmission becomes preferably smaller.

A thickness of a polyimide film in the invention may be appropriately determined depending on applications of a resulting surface metal film material (patterned metal material). However, the thickness is preferably from 3 to 150 μm, more preferably from 5 to 125 μm and still more preferably from 7.5 to 75 μm from the viewpoints of the flexibility and handling.

In the (a1) step, a polymer layer may be formed on both sides of the polyimide film.

In the case where the polymer layer is formed on both sides of the polyimide film like this, when the (a2) and (a3) steps described below are further performed, a surface metal film material on both sides of which a metal film is formed is obtained.

In the invention, when a surface graft polymerization method where an active species is imparted to a surface of the polyimide film and with this as a starting point a graft polymer is generated is used, at the generation of a graft polymer, a polyimide film on a surface of which an active point is imparted or a polyimide film having a polymerization initiation site such as mentioned above is preferably used. When such a polyimide film is used, active points are effectively used and thereby a graft polymer is more abundantly generated.

Herein, examples of methods of imparting an active point on a surface of the polyimide film include a UV/ozone process, a vacuum plasma process, an atmospheric pressure plasma process, a corona process, an ion beam process, a flame process, a plasma polymerization process, an excimer laser process, an alkali process, an electron beam process and a polyimide etching process.

In particular, a UV/ozone process or a plasma process is preferred from the viewpoints of the diversity of process conditions for imparting the active points and the convenience of the process.

The various kinds of processes such as mentioned above may be able to control the wettability of a surface of the polyimide film as well. Above-mentioned various kinds of surface treatments are preferably used, in particular, to heighten the hydrophilicity of the polyimide film surface more than the hydrophilicity before the processing.

When the wettability of the polyimide film surface is controlled, the affinity between the surface and a liquid composition containing a compound having a cyano group and a polymerizable group, which are described below, is heightened; accordingly, the coating property of the liquid composition and a surface state of an obtained coated film may be improved.

Various kinds of treatments such as mentioned above may be appropriately combined depending on an object.

(Formation of Polymer Layer)

With respect to the embodiment of polymer layer formation in the step (a), as described above, a method of utilizing coupling reaction of the functional group existing on the polyimide film surface and the reactive functional group which the polymer compound has in the terminals or the side chains, or the following method of surface graft polymerization (photograft polymerization) can be used.

In the invention, an aspect where after a compound having a cyano group and a polymerizable group is brought into contact with a polyimide film, energy is imparted to chemically bond the polymer directly with an entire surface of the polyimide film is preferred. That is, a composition containing a compound having a cyano group and a polymerizable group, while bringing into contact with a polyimide film surface, is directly bonded due to an active species generated on the polyi

The above-mentioned contact may be carried out by immersing the polyimide film into a liquid state composition containing the compound having the cyano group and the polymerizable group, however, from the viewpoint of the handling property and the production efficiency, as described later, it is preferable to form the layer comprising the composition containing the compound having the cyano group and the polymerizable group on the polyimide film surface by a coating method.

In what follows, a compound that is used to generate a graft polymer according to a surface graft polymerization method (photo-graft polymerization method) and has a cyano group and a polymerizable group will be described.

A cyano group of a compound that has a cyano group and a polymerizable group in the invention has a function of forming an interaction with a plating catalyst or a precursor thereof. However, the cyano group does not have water absorbing property and hydrophilicity high like a dissociative polar group (hydrophilic group). Accordingly, a polymer layer comprising the graft polymer having the functional group is capable of satisfying, for instance, conditions 1 and 2 described below.

A polymerizable group in a compound having a cyano group and a polymerizable group is a functional group that, upon imparting energy, bonds between compounds having a cyano group and a polymerizable group or between a compound having a cyano group and a polymerizable group and a polyimide film. Specific examples of the polymerizable groups include a vinyl group, a vinyloxy group, an allyl group, an acryloyl group, a methacryloyl group, an oxetane group, an epoxy group, an isocyanate group, a functional group containing an active hydrogen and an active group in an azo compound.

In general, as the polarity becomes higher, the water absorption rate tends to be higher. However, since the cyano groups each other interact so as to cancel out the polarity, a film becomes dense and, since the polarity of a polymer layer as a whole becomes lower, the water absorbing property becomes lower. When a catalyst is absorbed with a good solvent of the polymer layer in the (a2) step described below, the cyano groups are solvated to render interaction-free between the cyano groups to enable to interact with a plating catalyst. From what is mentioned above, a polymer layer having a cyano group is preferred in a point of exerting conflicting performance of being low in the hygroscopicity and interacting well with a plating catalyst.

Furthermore, the cyano group in the invention is further preferred to be an alkyl cyano group. This is because, while in an aromatic cyano group, an electron is attracted by an aromatic ring to be low in donating property of unpaired electrons important as the absorbing property to the plating catalyst, in an alkyl cyano group, the aromatic ring is not bonded to be preferable in a point of absorbing property to the plating catalyst.

In the invention, a compound that has a cyano group and a polymerizable group may be in any one of forms of monomer, macromonomer and polymer. However, among these, from the viewpoint of the formability of a polymer layer and the easiness of control, a polymer (polymer having a cyano group and a polymerizable group) is preferred to use.

The polymer having the cyano group and the polymerizable group may be polymers obtained by introducing ethylene addition polymerizable unsaturated groups (polymerizable groups) such as vinyl group, allyl group or (meth)acrylic group as the polymerizable group into homopolymers or copolymers obtained by using the monomer having the cyano group. The polymers having the cyano group and the polymerizable group are polymers having at least polymerizable group in the terminals or in the side chains, and the polymers having the polymerizable groups in the side chains

As the monomer having a cyano group, which is used to obtain the polymer having a cyano group and a polymerizable group, as far as it is a monomer having a cyano group, any one of monomers may be used. Specific examples thereof include what are cited below.

These may be used alone or in combination of two or more kinds thereof.

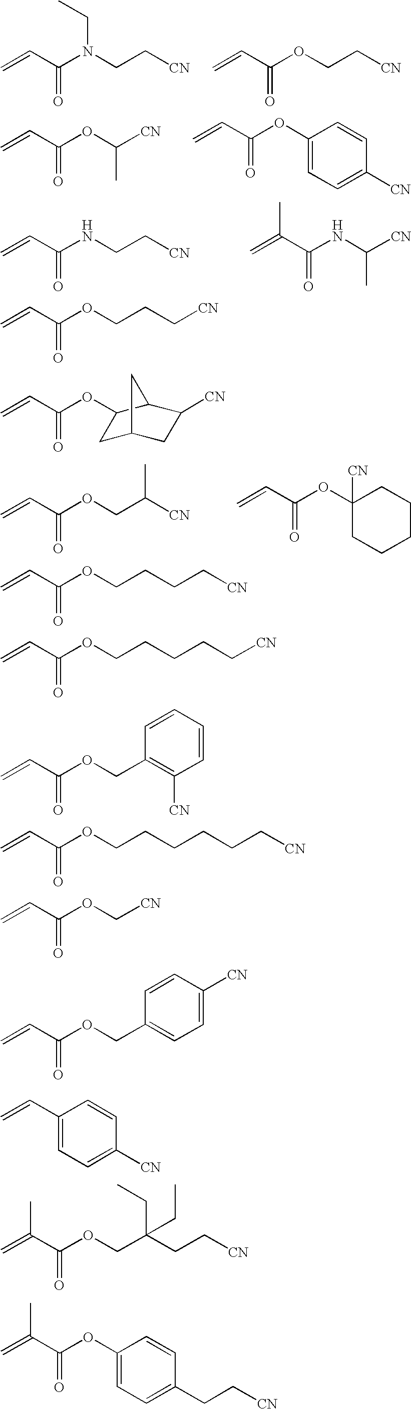

In a polymer having a cyano group and a polymerizable group, a unit derived from a monomer having a cyano group is contained, in a polymer having a cyano group and a polymerizable group, preferably in the range of 30 to 95% by mol and more preferably in the range of 40 to 80% by mol from the viewpoint of the formability of an interaction with a plating catalyst or a precursor thereof.

Furthermore, when a polymer having a cyano group and a polymerizable group is obtained, in addition to the monomer having a cyano group, other monomer may be used from the viewpoint of lowering the water absorbing property or improving the hydrophilicity. Examples of other monomers include general polymerizable monomers such as a diene monomer or an acrylic monomer. Among these, an acrylic monomer of unsubstituted alkyl is preferred. Specific preferable examples thereof include tertiary butyl acrylate, 2-ethylhexyl acrylate, butyl acrylate, cyclohexyl acrylate and benzyl methacrylate.

The polymers having the cyano group and the polymerizable group may be synthesized as follows.

Examples of the synthesis method may be i) a method of copolymerizing a monomer having the cyano group and a monomer having the polymerizable group; ii) a method of copolymerizing a monomer having the cyano group and a monomer having a double bond precursor and then introducing double bond by treatment with a base or the like; and iii) a method of reacting a polymer having the cyano group and a monomer having the polymerizable group and thereby introducing the double bond (introducing the polymerizable group). From the viewpoint of the synthesis suitability, the method ii) of copolymerizing a monomer having the cyano group and a monomer having a double bond precursor and then introducing double bond by treatment with a base or the like, and the method iii) of reacting a polymer having the cyano group and a monomer having the polymerizable group and thereby introducing the polymerizable group are preferable.

The monomer having the cyano group to be used for the synthesis of the polymer having the cyano group and the polymerizable group may be monomers similar to the above exemplified monomers having the cyano groups. The monomers may be used alone or in combination of two or more of them.

The monomer having the polymerizable group to be copolymerized with the monomer having the cyano group may be allyl(meth)acrylate, 2-allyloxyethyl methacrylate and the like.

The monomer having the double bond precursor may be 2-(3-chloro-1-oxopropoxy)ethyl methacrylate, 2-(3-bromo-1-oxopropoxy)ethyl methacrylate and the like.

The monomer having the polymerizable group to be utilized for introducing an unsaturated group by reaction with the functional group such as carboxyl group, amino group and its salts, hydroxyl and epoxy group in the polymer having the cyano group may be (meth)acrylic acid, glycidyl(meth)acrylate, ally glycidyl ether, 2-isocyanatoethyl(meth)acrylate and the like.

Specific examples of polymers that are preferably used in the invention and have a cyano group and a polymerizing group are shown below. However, the invention is not restricted thereto.

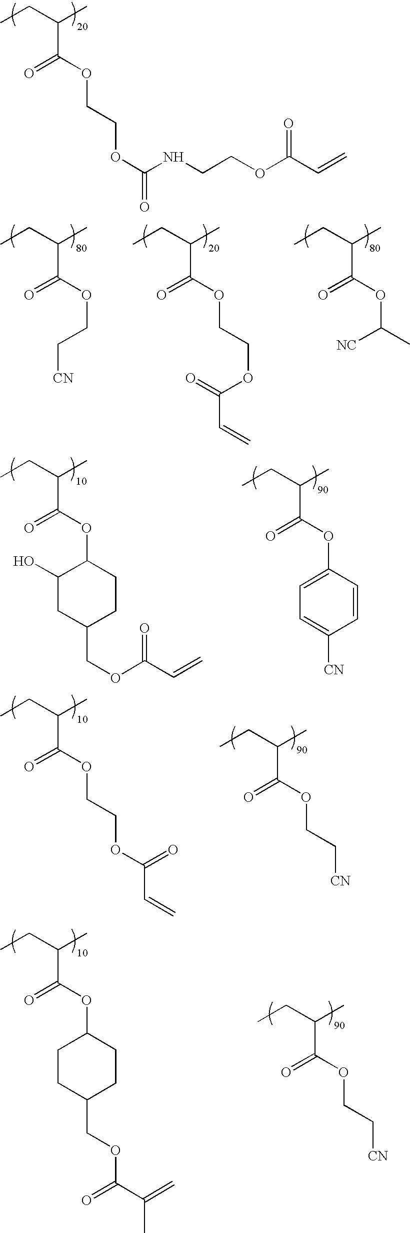

In the invention, as the polymers having a cyano group and a polymerizing group, polymers shown below (hereinafter, referred to as “cyano group-containing polymerizable polymer”) are preferably used.

The cyano group-containing polymerizable polymer in the invention is preferably a copolymer containing a unit represented by, for instance, Formula (1) shown below and a unit represented by Formula (2) shown below.

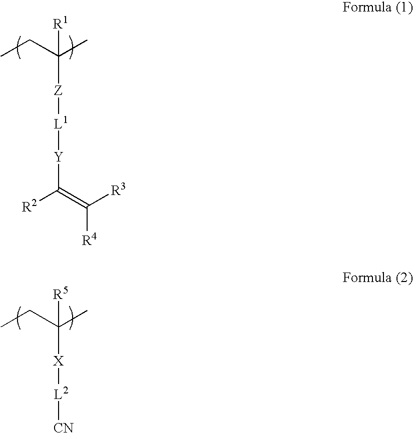

In the formulas (1) and (2), R¹ through R⁵, respectively and independently, represent a hydrogen atom or a substituted or unsubstituted alkyl group, X, Y and Z, respectively and independently, represent a single bond, substituted or unsubstituted divalent organic group, an ester group, an amide group or an ether group and L¹ and L², respectively and independently, represent a substituted or unsubstituted divalent organic group.

When the R¹ through R⁵ are a substituted or unsubstituted alkyl group, examples of unsubstituted alkyl groups include a methyl group, an ethyl group, a propyl group and a butyl group and examples of substituted alkyl groups include a methoxy group, a hydroxy group, and a methyl group, an ethyl group, a propyl group and a butyl group, which are substituted by a chlorine atom, a bromine atom or a fluorine atom.

Preferable examples of the R¹ include a hydrogen atom, a methyl group and a methyl group substituted by a hydroxy group or a bromine atom.

Preferable examples of the R² include a hydrogen atom, a methyl group and a methyl group substituted by a hydroxy group or a bromine atom.

The R³ is preferably a hydrogen atom.

The R⁴ is preferably a hydrogen atom.

Preferable examples of the R⁵ include a hydrogen atom, a methyl group, and a methyl group substituted by a hydroxy group or a bromine atom.

When the X, Y and Z each is a substituted or unsubstituted divalent organic group, as the divalent organic group, a substituted or unsubstituted aliphatic hydrocarbon group and a substituted or unsubstituted aromatic hydrocarbon group is cited.

Preferable examples of the substituted or unsubstituted aliphatic hydrocarbon groups include a methylene group, an ethylene group, a propylene group, a butylene group and ones obtained by substituting these groups with a methoxy group, a hydroxy group, a chlorine atom, a bromine atom or a fluorine atom.

Preferable examples of the substituted or unsubstituted aromatic hydrocarbon groups include an unsubstituted phenyl group or a phenyl group substituted by a methoxy group, a hydroxy group, a chlorine atom, a bromine atom or a fluorine atom.

Among these, —(CH₂)ₙ— (n is an integer from 1 through 3) is preferred and —CH₂— is more preferred.

L¹ is preferably a urethane bond or a divalent organic group having a urethane bond and more preferably a divalent organic group having a urethane bond, and, among these, ones having a total carbon atom content from 1 to 9 are preferred. Herein, the total carbon atom content of L¹ means a total number of carbon atoms contained in a substituted or unsubstituted divalent organic group represented by L¹.

Regarding a structure of L¹, more specifically, a structure represented by Formula (1-1) or Formula (1-2) shown below is preferred.

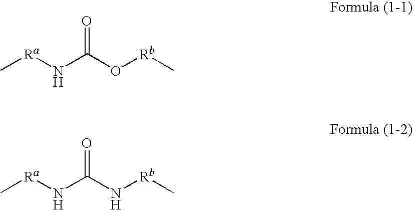

In the formulas (1-1) and (1-2), R^{a} and R^{b}, respectively and independently, represent a divalent organic group having two or more atoms selected from a group of a carbon atom, a hydrogen atom and an oxygen atom, and preferably a substituted or unsubstituted methylene group, ethylene group, propylene group or butylene group, an ethylene oxide group, a diethylene oxide group, a triethylene oxide group, a tetraethylene oxide group, a dipropylene oxide group, a tripropylene oxide group or a tetrapropylene oxide group.

Furthermore, the L² is preferably a straight chain, branched chain or cyclic alkylene group, an aromatic group or a group obtained by combining these. A group obtained by combining the alkylene group and aromatic group may be further intervened by an ether group, an ester group, an amide group, a urethane group or a urea group. Among these, the L² is preferred to have a total carbon atom content from 1 to 15 and particularly preferred to be unsubstituted. Herein, the total carbon atom content of the L² means a total number of carbon atoms contained in a substituted or unsubstituted divalent organic group represented by L².

Specifically, examples thereof include a methylene group, an ethylene group, a propylene group, a butylene group, a phenylene group, ones obtained by substituting these groups with a methoxy group, a hydroxy group, a chlorine atom, a bromine atom or a fluorine atom and groups obtained by combining these groups.

As the cyano group-containing polymerizable polymer in the invention, the unit represented by Formula (1) is preferably a unit represented by Formula (3) shown below.

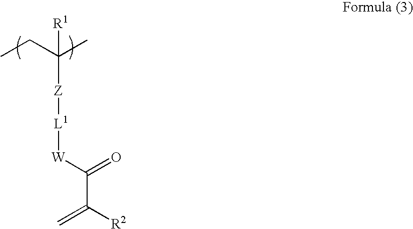

In Formula (3), R¹ and R², respectively and independently, represent a hydrogen atom or a substituted or unsubstituted alkyl group, Z represents a single bond, substituted or unsubstituted divalent organic group, an ester group, an amide group or an ether group, W represents an oxygen atom or NR (where R represents a hydrogen atom or an alkyl group, preferably a hydrogen atom or an unsubstituted alkyl group having 1 to 5 carbon atoms) and L¹ represents a substituted or unsubstituted divalent organic group.

R¹ and R² in the formula (3) are the same as R¹ and R² in Formula (1) and preferable examples thereof are also the same as that of Formula (1).

Z in the formula (3) is the same as Z in Formula (1) and preferable examples thereof are also same as that of Formula (1).

Furthermore, L¹ in the formula (3) as well is the same as L¹ in Formula (1) and preferable examples thereof are also the same as that of Formula (1).

As the cyano group-containing polymerizable polymer in the invention, the unit represented by Formula (3) is preferably a unit represented by Formula (4) shown below.

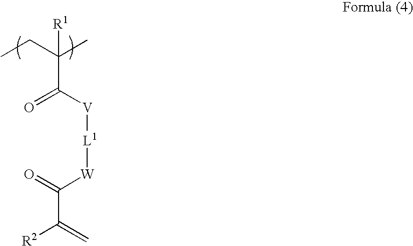

In Formula (4), R¹ and R², respectively and independently, represent a hydrogen atom or a substituted or unsubstituted alkyl group, V and W, respectively and independently, represent an oxygen atom or NR (where R represents a hydrogen atom or an alkyl group, preferably a hydrogen atom or an unsubstituted alkyl group having 1 to 5 carbon atoms) and L¹ represents a substituted or unsubstituted divalent organic group.

R¹ and R² in Formula (4) are the same as R¹ and R² in Formula (1) and preferable examples thereof are also the same as that of Formula (1).

L¹ in Formula (4) is the same as L¹ in Formula (1) and preferable examples thereof are also the same as that of Formula (1).

In Formulas (3) and (4), W is preferably an oxygen atom.

Furthermore, in Formulas (3) and (4), L¹ is preferably an unsubstituted alkylene group or a divalent organic group having a urethane bond or a urea bond and more preferably a divalent organic group having a urethane bond, and, among these, one having a total carbon atom content from 1 to 9 is particularly preferred.

As the cyano group-containing polymerizable polymer in the invention, the unit represented by Formula (2) is preferably a unit represented by Formula (5) shown below.

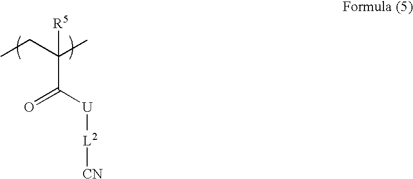

In Formula (5), R⁵ represents a hydrogen atom or a substituted or unsubstituted alkyl group, U represents an oxygen atom or NR′ (where R′ represents a hydrogen atom or an alkyl group, preferably a hydrogen atom or an unsubstituted alkyl group having 1 to 5 carbon atoms) and L² represents a substituted or unsubstituted divalent organic group.

R⁵ in Formula (5) is the same as R¹ and R² in Formula (1) and preferably a hydrogen atom.

L² in the formula (5) has the same meaning as L² in Formula (2) and is preferably a straight chain, branched chain or cyclic alkylene group, an aromatic group or a group obtained by combining these.

In particular, in Formula (5), a site linking with a cyano group in the L² is preferably a divalent organic group having a straight chain, branched chain or cyclic alkylene group and, among these, preferably a divalent organic group having a total carbon content from 1 to 10.

Furthermore, as another preferable aspect, a linking site with a cyano group in the L² in Formula (5) is preferably a divalent organic group having an aromatic group and, among these, the divalent organic group preferably has the total carbon content from 6 to 15.

The cyano group-containing polymerizable polymer in the invention is constituted containing units represented by Formulae (1) through (5) and is a polymer having a polymerizable group and a cyano group in a side chain.

The cyano group-containing polymerizable polymer is synthesized as shown below.

Examples of kinds of polymerization reactions when a cyano group-containing polymerizable polymer in the invention is synthesized include a radical polymerization process, a cationic polymerization process and an anionic polymerization process. From the viewpoint of the reaction control, a radical polymerization process or a cationic polymerization process is preferably used.

The cyano group-containing polymerizable polymer in the invention is different in a synthesis process thereof between 1) a case where a polymerization form forming a polymer main chain and a polymerization form of a polymerizable group introduced in a side chain are different and 2) a case where a polymerization form forming a polymer main chain and a polymerization form of a polymerizable group introduced in a side chain are same.

1) Case where a Polymerization Form Forming a Polymer Main Chain and a Polymerization Form of a Polymerizable Group Introduced in a Side Chain are Different

When a polymerization form forming a polymer main chain and a polymerization form of a polymerizable group introduced in a side chain are different, 1-1) an aspect where a polymer main chain is formed according to a cationic polymerization process and a polymerizable group introduced in a side chain is polymerized according to a radical polymerization process, and 1-2) an aspect where a polymer main chain is formed according to the radical polymerization process and a polymerizable group introduced in a side chain is polymerized according to the cationic polymerization process are cited.

1-1) Aspect where a Polymer Main Chain is Formed According to the Cationic Polymerization Process and a Polymerizable Group Introduced in a Side Chain is Polymerized According to the Radical Polymerization Process

In the invention, examples of monomers used in an aspect where a polymer main chain is formed according to the cationic polymerization process and a polymerizable group introduced in a side chain is polymerized according to a radical polymerization process include compounds cited below.

Monomers Used for Forming Polymerizable Group-Containing Unit

Examples of monomers used for forming a polymerizable group-containing unit used in the aspect include vinyl(meth)acrylate, allyl(meth)acrylate, 4-(meth)acryloylbutane vinyl ether, 2-(meth)acryloylethane vinyl ether, 3-(meth)acryloylpropane vinyl ether, (meth)acryloyloxy diethylene glycol vinyl ether, (meth)acryloyloxytriethylene glycol vinyl ether, (meth)acryloyl 1st terpineol, 1-(meth)acryloyloxy-2-methyl-2-propene, 1-(meth)acryloyloxy-3-methyl-3-butene, 3-methylene-2-(meth)acryloyloxy-norbornane, 4,4′-ethylidene diphenol di(meth)acrylate, methacrolein di(meth)acryloyl acetal, p-((meth)acryloylmethyl)styrene, allyl(meth)acrylate, vinyl 2-(bromomethyl)acrylate and allyl 2-(hydroxymethyl)acrylate.

Monomers Used for Forming Cyano Group-Containing Unit

Examples of monomers used for forming a cyano group-containing unit used in the aspect include 2-cyanoethyl vinyl ether, cyanomethyl vinyl ether, 3-cyanopropyl vinyl ether, 4-cyanobutyl vinyl ether, 1-(p-cyanophenoxy)-2-vinyloxy-ethane, 1-(o-cyanophenoxy)-2-vinyloxy-ethane, 1-(m-cyanophenoxy)-2-vinyloxy-ethane, 1-(p-cyanophenoxy)-3-vinyloxy-propane, 1-(p-cyanophenoxy)-4-vinyloxy-buthane, o-cyanobenzyl vinyl ether, m-cyanobenzyl vinyl ether, p-cyanobenzyl vinyl ether, allyl cyanide, allyl cyanoacetate and compounds shown below.

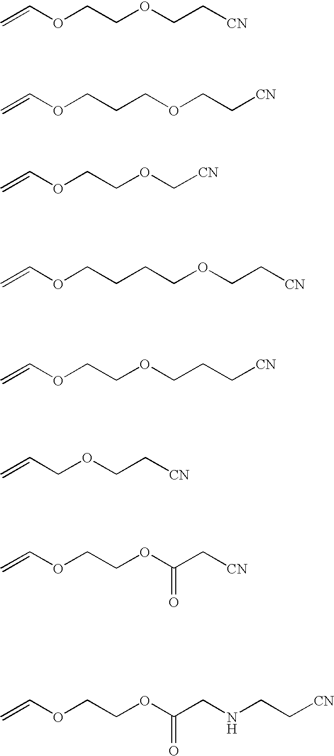

Regarding a polymerization process, a process described in “Jikken Kagaku Kouza-Koubunshi Kagaku (Experimental Chemistry-Polymer Chemistry)”, Chapter 2-4 (p 74) or a general cationic polymerization process described in “Koubunshi Gousei no Jikken Houhou (Experimental Method of Polymer Synthesis)”, T. Ohtsu, Chapter 7 (p 195) is used. In the cationic polymerization process, protonic acid, a metal halide, an organometallic compound, an organic salt, a metal oxide and a solid acid or halogen is used as an initiator. Among these, as an initiator large in the activity and capable of synthesizing a higher molecular weight polymer, a metal halide and an organometallic compound are preferably used.

Specific examples thereof include boron trifluoride, boron trichloride, aluminum chloride, aluminum bromide, titanium tetrachloride, tin tetrachloride, tin bromide, phosphorus pentafluoride, antimony chloride, molybdenum chloride, tungsten chloride, iron chloride, dichloroethyl aluminum, chlorodiethyl aluminum, dichloromethyl aluminum, chlorodimethyl aluminum, trimethyl aluminum, trimethyl zinc and methyl Grignard.

1-2) Aspect where a Polymer Main Chain is Formed According to a Radical Polymerization Process and a Polymerizable Group Introduced in a Side Chain is Polymerized According to a Cationic Polymerization Process

In the invention, examples of monomers used in an aspect where a polymer main chain is formed according to a radical polymerization process and a polymerizable group introduced in a side chain is polymerized according to a cationic polymerization process include compounds shown below.

Monomer Used for Forming Polymerizable Group-Containing Unit

Monomers same as that used for forming a polymerizable group-containing unit cited in the aspect of the 1-1) are used.

Monomer Used for Forming Cyano Group-Containing Unit

Examples of monomers used for forming a cyano group-containing unit used in the aspect include cyanomethyl(meth)acrylate, 2-cyanoethyl(meth)acrylate, 3-cyanopropyl(meth)acrylate, 2-cyanopropyl(meth)acrylate, 1-cyanoethyl(meth)acrylate, 4-cyanobutyl(meth)acrylate, 5-cyanopentyl(meth)acrylate, 6-cyanohexyl(meth)acrylate, 7-cyanoheptyl(meth)acrylate, 8-cyanooctyl(meth)acrylate, 2-cyanoethyl-(3-(bromomethyl)acrylate), 2-cyanoethyl-(3-hydroxymethyl)acrylate), p-cyanophenyl(meth)acrylate, o-cyanophenyl(meth)acrylate, m-cyanophenyl(meth)acrylate, 5-(meth)acryloyl-2-carbonitrilo-norbornene, 6-(meth)acryloyl-2-carbonitrilo-norbornene, 1-cyano-1-(meth)acryloyl-cyclohexane, 1,1-dimethyl-1-cyano-methyl(meth)acrylate, 1-methyl-1-ethyl-1-cyano-methyl(meth)acrylate, o-cyanobenzyl(meth)acrylate, m-cyanobenzyl(meth)acrylate, p-cyanobenzyl(meth)acrylate, 1-cyanocyaloheptyl acrylate, 2-cyanophenyl acrylate, 3-cyanophenyl acrylate, vinyl cyanoacetate, vinyl 1-cyano-1-cyclopropane carbonate, allyl cyanoacetate, allyl 1-cyano-1-cyclopropane carbonate, N,N-dicyanomethyl(meth)acrylamide, N-cyanophenyl(meth)acrylamide, allyl cyanomethyl ether, allyl-o-cyanoethyl ether, allyl-m-cyanobenzyl ether and allyl-p-cyanobenzyl ether.

Furthermore, monomers having a structure in which hydrogen atoms of the monomer are partially substituted with a hydroxyl group, an alkoxy group, a halogen atom or a cyano group may be used as well.

Regarding a polymerization process, a process described in “Jikken Kagaku Kouza-Koubunshi Kagaku (Experimental Chemistry-Polymer Chemistry)”, Chapter 2-2 (p 34) or a general radical polymerization process described in “Koubunshi Gousei no Jikken Houhou (Experimental Method of Polymer Synthesis)”, T. Ohtsu, Chapter 5 (p 125) is used. As the initiator of the radical polymerization process, a high temperature initiator necessary to heat to 100° C. or more, a normal initiator that starts by heating to a temperature from 40 to 100° C. and a redox initiator that starts at a very low temperature are known. However, a normal initiator is preferred from the viewpoint of the stability of the initiator and easiness of handling of a polymerization reaction.

Examples of the normal initiators include benzoyl peroxide, lauroyl peroxide, peroxodisulfate, azobisisobutyro nitrile and azobis-2,4-dimethylvaleronitrile.

2) Case where a Polymerization Mode for Forming a Polymer Main Chain and a Polymerization Mode of a Polymerizable Group Introduced in a Side Chain are Same

When a polymerization mode for forming a polymer main chain and a polymerization mode of a polymerizable group introduced in a side chain are same, 2-1) an aspect where both are the cationic polymerization process and 2-2) an aspect where both are the radical polymerization process are cited.

2-1) Aspect where Both are Cationic Polymerization Process

In the aspect where both are the cationic polymerization process, as a monomer having a cyano group, monomers same as those used for forming a cyano group-containing unit cited in the 1-1) are used.

From the viewpoint of inhibiting the gelling from occurring during the polymerization, a process where, after a polymer having a cyano group is synthesized in advance, the polymer and a compound having a group polymerizable according to the cationic polymerization process (hereinafter, appropriately, referred to as “reactive compound”) are allowed react to introduce a polymerizable group according to the cationic polymerization process in a side chain is preferably used.

The polymer having a cyano group preferably has a reactive group shown below to react with the reactive compound.

Furthermore, the polymer having a cyano group and the reactive compound are preferably appropriately selected so that functional groups may be combined as shown below.

Examples of specific combinations of (reactive group of polymer, functional group of reactive compound) include (carboxyl group, carboxyl group), (carboxyl group, epoxy group), (carboxyl group, isocyanate group), (carboxyl group, benzyl halide), (hydroxyl group, carboxyl group), (hydroxyl group, epoxy group), (hydroxyl group, isocyanate group), (hydroxyl group, benzyl halide), (isocyanate group, hydroxyl group) and (isocyanate group, carboxyl group).

Herein, specific examples of the reactive compounds include allyl alcohol, 4-hydroxybuthane vinyl ether, 2-hydroxyethane vinyl ether, 3-hydroxypropane vinyl ether, hydroxytriethylene glycol vinyl ether, 1st terpineol, 2-methyl-2-propenol, 3-methyl-3-butenol, 3-methylene-2-hydroxy-norbornane and p-(chloromethyl)styrene.

2-2) Aspect where Both are Radical Polymerization Process

In the aspect where both are the radical polymerization process, as the polymerization process, i) a process where a monomer having a cyano group and a monomer having a polymerizable group are copolymerized, ii) a process where a monomer having a cyano group and a monomer having a double bond precursor are copolymerized, followed by treating with a base to introduce a double bond and iii) a process where a polymer having a cyano group and a monomer having a polymerizable group are allowed to react to introduce a double bond (introducing a polymerizable group) are cited. From the viewpoint of synthesis aptitude, ii) a process where a monomer having a cyano group and a monomer having a double bond precursor are copolymerized, followed by treating with a base to introduce a double bond and iii) a process where a polymer having a cyano group and a monomer having a polymerizable group are allowed to react to introduce a polymerizable group are preferably cited.

Examples of the monomers having a polymerizable group, which are used in the synthesis process of the i), include allyl(meth)acrylate and compounds shown below.

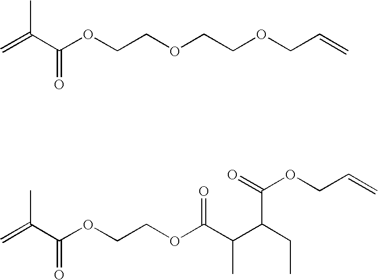

Examples of the monomers having a double bond precursor, which are used in the synthesis method ii), include compounds represented by Formula (a) below.

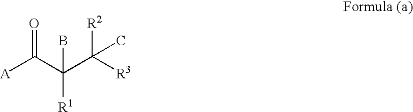

In Formula (a), A represents an organic atomic group having a polymerizable group, R1 through R3, respectively and independently, represent a hydrogen atom or a mono-valent organic group, and B and C each represent an elimination group eliminated due to an elimination reaction. In the elimination reaction here, C is extracted due to an action of a base to eliminate B. B is preferably eliminated as an anion and C is preferably eliminated as a cation.

Examples of the compounds represented by Formula (a) specifically include compounds shown below.

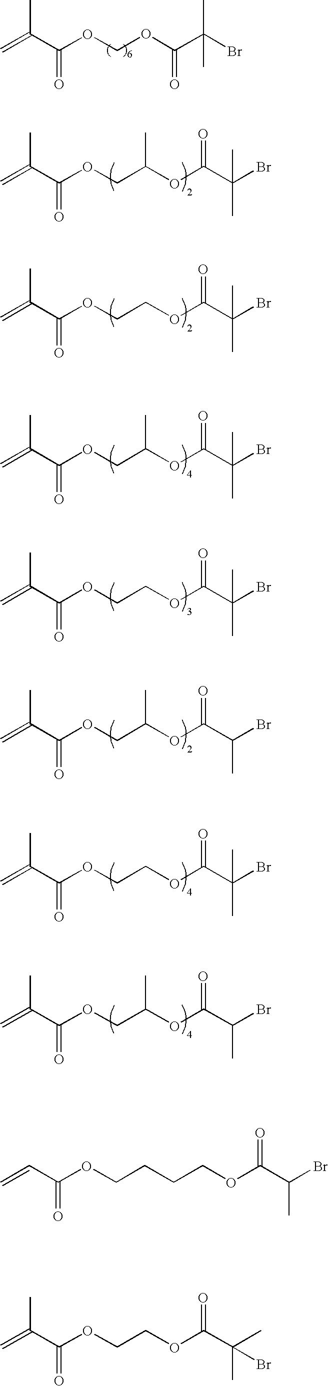

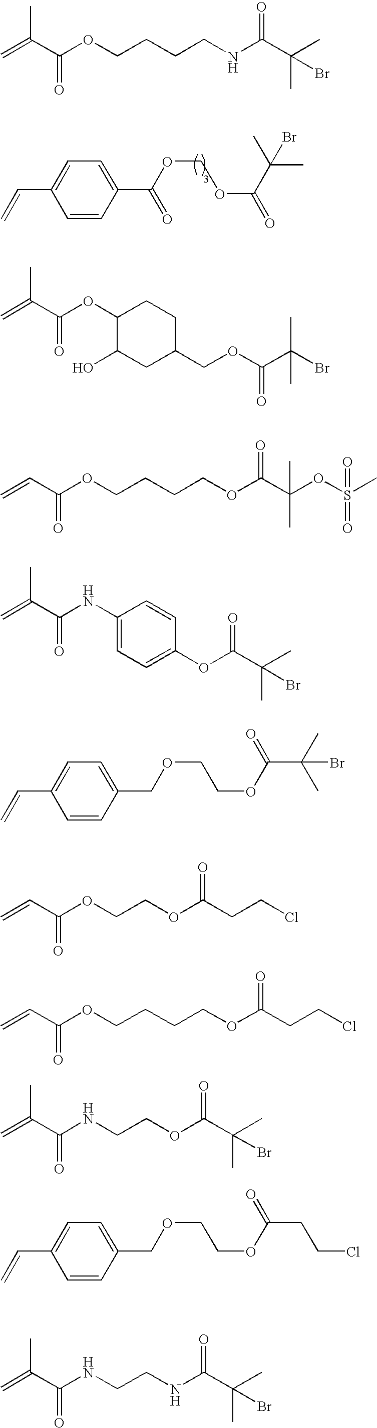

In the synthesis process of the ii), in order to convert the double bond precursor to a double bond, as shown below, a process where elimination groups represented by B and C are removed by use of an elimination reaction, that is, a reaction where C is extracted by an action of a base to eliminate B is used.

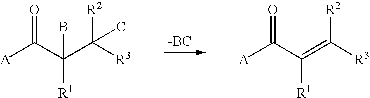

Preferable examples of the bases used in the elimination reaction include hydrides, hydroxides or carbonates of alkali metals, organic amine compounds and metal alkoxide compounds. Preferable examples of hydrides, hydroxides or carbonates of alkali metals include sodium hydride, calcium hydride, potassium hydride, sodium hydroxide, potassium hydroxide, calcium hydroxide, potassium carbonate, sodium carbonate, potassium hydrogen carbonate and sodium hydrogen carbonate. Preferable examples of organic amine compounds include trimethylamine, triethylamine, diethylmethylamine, tributylamine, triisobutylamine, trihexylamine, trioctylamine, N,N-dimethylcyclohexylamine, N,N-diethylcyclohexylamine, N-methyldicyclohexylamine, N-ethyldicyclohexylamine, pyrrolidine, 1-methylpyrrolidine, 2,5-dimethylpyrrolidine, piperidine, 1-methylpiperidine, 2,2,6,6-tetramethylpiperidine, piperadine, 1,4-dimethylpiperadine, quinuclidine, 1,4-diazabicyclo[2,2,2]-octane, hexamethylenetetramine, morpholine, 4-methylmorpholine, pyridine, picoline, 4-dimethylaminopyridine, lutidine, 1,8-diazabicyclo[5,4,0]-7-undecene (DBU), N,N′-dicyclohexylcarbodiimide (DCC), diisopropylethylamine and Schiff's base. Preferable examples of the metal alkoxide compounds include sodium methoxide, sodium ethoxide and potassium t-butoxide. The bases may be used alone or in combination of two or more kinds thereof.

Furthermore, examples of solvents used when a base is added in the elimination reaction include ethylene dichloride, cyclohexanone, methyl ethyl ketone, acetone, methanol, ethanol, propanol, butanol, ethylene glycol monomethyl ether, ethylene glycol monoethyl ether, 2-methoxyethyl acetate, 1-methoxy-2-propanol, 1-methoxy-2-propyl acetate, N,N-dimethylformamide, N,N-dimethylacetamide, dimethyl sulfoxide, toluene, ethyl acetate, methyl lactate, ethyl lactate and water. The solvents may be used alone or in combination of two or more kinds thereof.

An amount of the base used may be equal to or less than or equal to or more than an amount equivalent to an amount of a particular functional group in the compound (elimination groups represented by B and C). When the base is used excessively, after the elimination reaction, an acid is preferably added to remove the excessive base.

The polymer having a cyano group, which is used in a synthesis process of the iii), is synthesized by radical polymerizing a monomer used for forming a cyano group-containing unit cited in an aspect of the 1-2) and a monomer having a reactive group for introducing a double bond.

Examples of the monomers having a reactive group for introducing a double bond include monomers having a carboxyl group, a hydroxide group, an epoxy group, or an isocyanate group as the reactive group.

Examples of carboxyl group-containing monomers include (meth)acrylic acid, itaconic acid, vinyl benzoate, ARONICS M-5300, M-5400 and M-5600 (trade name, manufactured by Toagosei Co., Ltd.), ACRYL ESTER PA and HH (trade name, manufactured by Mitsubishi Rayon Co., Ltd.), LIGHTACRYLATE HOA-HH (trade name, manufactured by Kyoeisha Chemical Co., Ltd.) and NK ESTER SA and A-SA (trade name, manufactured by Nakamura Chemical Co., Ltd.).

Examples of hydroxyl group-containing monomers include 2-hydroxyethyl(meth)acrylate, 4-hydroxybutyl(meth)acrylate, 2-hydroxypropyl(meth)acrylate, 2-hydroxybutyl(meth)acrylate, 1-(meth)acryloyl-3-hydroxy-adamantine, hydroxymethyl(meth)acrylamide, (2-hydroxyethyl)-(meth)acrylate, 3-chloro-2-hydroxypropyl(meth)acrylate, 3,5-dihydroxypentyl(meth)acrylate, 1-hydroxymethyl-4-(meth)acryloylmethyl-cyclohexane, 2-hydroxy-3-phenoxypropyl(meth)acrylate, 1 -methyl-2-acryloyloxypropyl phthalic acid, 2-acryloyloxyethyl-2-hydroxyethyl phthalic acid, 1 -methyl-2-acryloyloxyethyl-2-hydroxypropyl phthalic acid, 2-acryloyloxyethyl-2-hydroxy-3-chloropropyl phthalic acid, ARONICS M-554, M-154, M-555, M-155 and M-158 (trade name, manufactured by Toagosei Co., Ltd.), BLENMER PE-200, PE-350, PP-500, PP-800, PP-1000, 70PEP-350B and 55PET800 (trade name, manufactured by Nippon Oil & Fats Co., Ltd.), and lactone-modified acrylates having a structure shown below.

CH₂═CRCOOCH₂CH₂[OC(═O)C₅H₁₀]ₙOH

(where R═H or Me, n=1 through 5)

Examples of monomers having an epoxy group include glycidyl(meth)acrylate and CYCLOMER A and M (trade name, manufactured by Daicel Chemical Industries, Ltd.).

Examples of monomers having an isocyanate group include KARENZ AOI and MOI (trade name, manufactured by Showa Denko K. K.).

The polymer having a cyano group, which is used in a polymerization process of iii), may further contain a third copolymerization component.

In the synthesis process of the iii), as the monomer having a polymerizable group that is allowed to react with a polymer having a cyano group, though different depending on a kind of a reactive group in the polymer having a cyano group, monomers having functional groups in combinations shown below may be used.

That is, examples of combinations of (reactive group of polymer, functional group of monomer) include (carboxyl group, carboxyl group), (carboxyl group, epoxy group), (carboxyl group, isocyanate group), (carboxyl group, benzyl halide), (hydroxyl group, carboxyl group), (hydroxyl group, epoxy group), (hydroxyl group, isocyanate group), (hydroxyl group, benzyl halide), (isocyanate group, hydroxyl group), (isocyanate group, carboxyl group) and (epoxy group, carboxyl group).

Specifically, monomers shown below may be used.

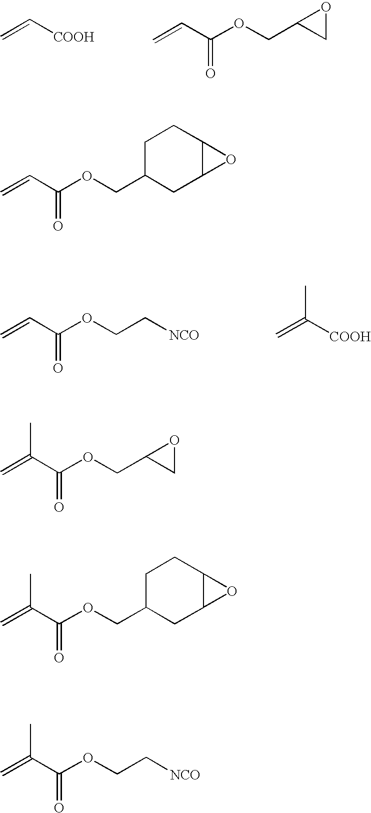

When, in the cyano group-containing polymerizable polymer in the invention, L¹ in Formula (1), (3) or (4) has a structure of a divalent organic group having a urethane bond, a synthesis process (hereinafter, referred to as synthesis process A) below is preferably used to synthesize.

That is, according to the synthesis process A in the invention, at least in a solvent, a polymer having a hydroxyl group in a side chain and a compound having an isocyanate group and a polymerizable group are used to add the isocyanate group to the hydroxyl group, thereby a urethane bond in L¹ is formed.

The polymer having a hydroxyl group in a side chain, which is used in the synthesis process A, is preferably a copolymer between the monomer used for forming a cyano group-containing unit cited in the aspect of the 1-2) and a hydroxyl group-containing (meth)acrylate cited below.

As the hydroxyl group-containing (meth)acrylate, one same in the kind as the hydroxyl group-containing monomer cited as one of monomers having a reactive group for introducing the double bond may be used.

The polymer having a hydroxyl group in a side chain, which is used in the synthesis process A, may further contain a third copolymerization component.

Among the polymers having a hydroxyl group in a side chain as mentioned above, from the viewpoint of synthesis of a high molecular weight polymer, a polymer synthesized with a raw material from which a bifunctional acrylate by-produced at the synthesis of the hydroxy group-containing (meth)acrylate is removed may be used as a raw material. As a purifying process, distillation and column purification are preferred. One synthesized with hydroxyl group-containing (meth)acrylate obtained sequentially going through steps (I) through (IV) shown below is more preferred.

(I) A step where a mixture of hydroxyl group-containing (meth)acrylate and bifunctional acrylate by-produced at the synthesis of the hydroxyl group-containing (meth)acrylate is dissolved in water,

(II) a step where after a first organic solvent immiscible with water is added to a resulting aqueous solution, a layer containing the first organic solvent and the bifunctional acrylate is isolated from an aqueous layer,

(III) a step where a compound higher in the water solubility than the hydroxyl group-containing (meth)acrylate is dissolved in the aqueous layer and

(IV) a step where a second organic solvent is added to the aqueous layer to extract the hydroxyl group-containing (meth)acrylate, followed by enriching.

The mixture used in the (I) step includes a hydroxyl group-containing (meth)acrylate and bifunctional acrylate that is an impurity by-produced when the hydroxyl group-containing (meth)acrylate is synthesized and corresponds to a generally commercially available product of the hydroxyl group-containing (meth)acrylate.

In the (I) step, the commercially available product (mixture) is dissolved in water to prepare an aqueous solution.

In the (II) step, a first organic solvent immiscible with water is added to the aqueous solution obtained in the (I) step. Examples of the first organic solvents used herein include ethyl acetate, diethyl ether, benzene and toluene.

Thereafter, a layer containing the first organic solvent and the bifunctional acrylate (oil layer) is separated from the aqueous solution (aqueous layer).

In the (III) step, a compound higher in the water solubility than the hydroxyl group-containing (meth)acrylate is dissolved in the aqueous layer separated from the oil layer in the (II) step.

Examples of the compounds used herein and higher in the water solubility than the hydroxyl group-containing (meth)acrylate used here include inorganic salts such as alkali metal salt such as sodium chloride or potassium chloride or alkaline earth metal salts such as magnesium sulfate or calcium sulfate.

In the (IV) step, a second organic solvent is added to the aqueous layer to extract hydroxyl group-containing (meth)acrylate, followed by enriching.

Examples of the second organic solvents used herein include ethyl acetate, diethyl ether, benzene and toluene. The second organic solvent may be the same as the first organic solvent or different therefrom.

In the enrichment in the (IV) step, drying with anhydrous magnesium sulfate or reduced pressure distillation is used.

An isolated matter containing a hydroxyl group-containing (meth)acrylate obtained by going through the (I) through (IV) steps preferably contains the bifunctional acrylate from 0.1% by mass or less in a total mass. That is, by going through the (I) through (IV) steps, bifunctional acrylate that is an impurity is removed from the mixture to purify the hydroxyl group-containing (meth)acrylate.

A more preferable range of a content of bifunctional acrylate is 0.05% by mass or less in a total mass of the isolated matter, and, the smaller, the better.

When thus purified hydroxyl group-containing (meth)acrylate is used, the bifunctional acrylate that is an impurity becomes difficult to adversely affect on a polymerization reaction; accordingly, a nitrile group-containing polymerizable polymer having an weight average molecular weight of 20000 or more is synthesized.

As the hydroxyl group-containing (meth)acrylate used in the (I) step, one cited as the hydroxyl group-containing (meth)acrylate used when a polymer having a hydroxyl group in a side chain, which is used in the synthesis process A, is synthesized may be used. Among these, from the viewpoint of the reactivity with isocyanate, a monomer having a primary hydroxyl group is preferred, and, furthermore, from the viewpoint of heightening a polymerizable group ratio per unit weight of the polymer, hydroxyl group-containing (meth)acrylate having a molecular weight from 100 to 250 is preferred.

Examples of the compounds having an isocyanate group and a polymerizable group, which are used in the synthesis process A, include 2-acryloyloxyethylisocyanate (KARENZ AOI (trade name, manufactured by Showa K.K.)) and 2-methacryloxyisocyanate (KARENZ MOI (trade name, manufactured by Showa K.K.)).

The solvent used in the synthesis process A preferably has the SP value (calculated according to Okitu method) from 20 to 23 MPa^{1/2}. Specific examples thereof include ethylene glycol diacetate, diethylene glycol diacetate, propylene glycol diacetate, methyl acetoacetate, ethyl acetoacetate, 1,2,3-triacetoxy-propane, cyclohexanone, 2-(1-cyclohexenyl)cyclohexanone, propionitrile, N-methylpyrrolidone, dimethylacetamide, acetylacetone, acetophenone, triacetin, 1,4-dioxane and dimethyl carbonate.

Among these, from the viewpoint of synthesizing a high molecule polymer, an ester-based solvent is preferred and, in particular, diacetate-based solvents such as ethylene glycol diacetate or diethylene glycol diacetate and dimethyl carbonate are more preferred.

The SP value of a solvent in the invention is calculated according to an Okitu's method (T. Okitu, “Journal of The Adhesion Society of Japan”, 29(3) (1993)). Specifically, the SP value is calculated according to a formula shown below. Herein, ΔF is a value described in the literature.

SP value (δ)=Σ ΔF (Molar Attraction Constants)/V (Molar Volume)

Thus synthesized cyano group-containing polymer of the invention has ratios of polymerizable group-containing units and cyano group-containing units preferably in ranges shown below to an entirety of copolymerization components.

That is, the polymerizable group-containing units are contained relative to an entirety of the copolymerization components preferably from 5 to 50% by mol and more preferably from 5 to 40% by mol. When the content is 5% by mol or less, the reactivity (curability, polymerizability) is deteriorated and when the content is 50% by mol or more the gelling tends to occur to result in difficulty in the synthesis.

Furthermore, the cyano group-containing units are contained, to an entirety of copolymerizable components, preferably from 5 to 95% by mol and more preferably from 10 to 95% by mol from the viewpoint of absorptive property to the plating catalyst.

The cyano group-containing polymerizable polymer in the invention may contain other units in addition to the cyano group-containing units and the polymerizable group-containing units. As a monomer that is used to form the other unit, as far as it does not damage advantages of the invention, any one of monomers may be used.

Specific examples of the monomers used for forming the other unit include monomers capable of forming a main chain skeleton such as an acryl resin skeleton, a styrene resin skeleton, a phenol resin (phenol formaldehyde resin) skeleton, a melamine resin (polycondensate of melamine and formaldehyde) skeleton, a urea resin (polycondensate of urea and formaldehyde) skeleton, a polyester resin skeleton, a polyurethane resin skeleton, a polyimide resin skeleton, a polyolefin resin skeleton, a polycycloolefin resin skeleton, a polystyrene resin skeleton, a polyacrylic resin skeleton, an ABS resin (polymer of acrylonitrile, butadiene and styrene) skeleton, a polyamide resin skeleton, a polyacetal resin skeleton, a polycarbonate resin skeleton, a polyphenylene ether resin skeleton, a polyphenylene sulfide resin skeleton, a polysulfone resin skeleton, a polyethersulfone resin skeleton, a polyaryl resin skeleton, a polyetheretherketone resin skeleton or a polyamideimide resin skeleton.

The main chain skeletons may be main chain skeletons of the cyano group-containing unit and polymerizable group-containing unit.

However, in the case where a polymerizable group is reacted with a polymer and introduced therein as mentioned above, when the polymerizable group is difficult to introduce 100%, a slight amount of a reactive portion may remain and work as a third unit.

Specifically, when a polymer main chain is formed according to a radical polymerization process, unsubstituted (meth)acrylic acid esters such as ethyl(meth)acrylate, butyl(meth)acrylate, hexyl(meth)acrylate, 2-ethylhexyl(meth)acrylate, cyclohexyl(meth)acrylate, benzyl(meth)acrylate or stearyl(meth)acrylate; halogen substituted (meth)acrylic acid esters such as 2,2,2-trifluoroethyl(meth)acrylate, 3,3,3-trifluoropropyl(meth)acrylate or 2-chloroethyl(meth)acrylate; ammonium group substituted (meth)acrylic acid esters such as 2-(meth)acryloyloxyethyltrimethyl ammonium chloride; (meth)acrylamides such as butyl(meth)acrylamide, isopropyl(meth)acrylamide, octyl(meth)acrylamide or dimethyl(meth)acrylamide; styrenes such as styrene, vinyl benzoate or p-vinylbenzyl ammonium chloride; vinyl compounds such as N-vinylcarbazole, vinyl acetate, N-vinylacetamide or N-vinylcaprolactam; or others such as dimethylaminoethyl(meth)acrylate, diethylaminoethyl(meth)acrylate, 2-ethylthio-ethyl(meth)acrylate, (meth)acrylic acid or 2-hydroxyethyl(meth)acrylate.

Macromonomers obtained from the above-mentioned monomers may be used as well.

When a polymer main chain is formed according to a cationic polymerization process, vinyl ethers such as ethyl vinyl ether, butyl vinyl ether, isobutyl vinyl ether, cyclohexyl vinyl ether, ethylene glycol vinyl ether, di(ethylene glycol) vinyl ether, 1,4-butanediol vinyl ether, 2-chloroethyl vinyl ether, 2-ethylhexyl vinyl ether, vinyl acetate, 2-vinyloxytetrahydropyrane, vinyl benzoate or vinyl butylate; styrenes such as styrene, p-chlorostyrene or p-methoxystyrene; and terminal ethylenes such as allyl alcohol or 4-hydroxy-1-butene may be used.

A weight average molecular weight of the cyano group-containing polymerizable polymer in the invention is preferably 1000 or more and 700000 or less and more preferably 2000 or more and 200000 or less. In particular, from the viewpoint of the polymerization sensitivity, a weight average molecular weight of the cyano group-containing polymerizable polymer in the invention is preferably 20000 or more.

Regarding a degree of polymerization of the cyano group-containing polymerizable polymer, one of 10-mer or more is preferably used and one of 20-mer or more is more preferably used. Furthermore, one of 7000-mer or less is preferred, one of 3000-mer or less is more preferred, one of 2000-mer or less is still more preferred and one of 1000-mer or less is particularly preferred.

Preferable ranges of the molecular weight and degree of polymerization described herein are preferably applied as well to polymers having a cyano group and a polymerizable group other than the cyano group-containing polymerizable polymers used in the invention.

Specific examples of the cyano group-containing polymerizable polymers in the invention will be shown below without restricting thereto.

The weight average molecular weight of each of the specific examples is from 3000 to 100000.

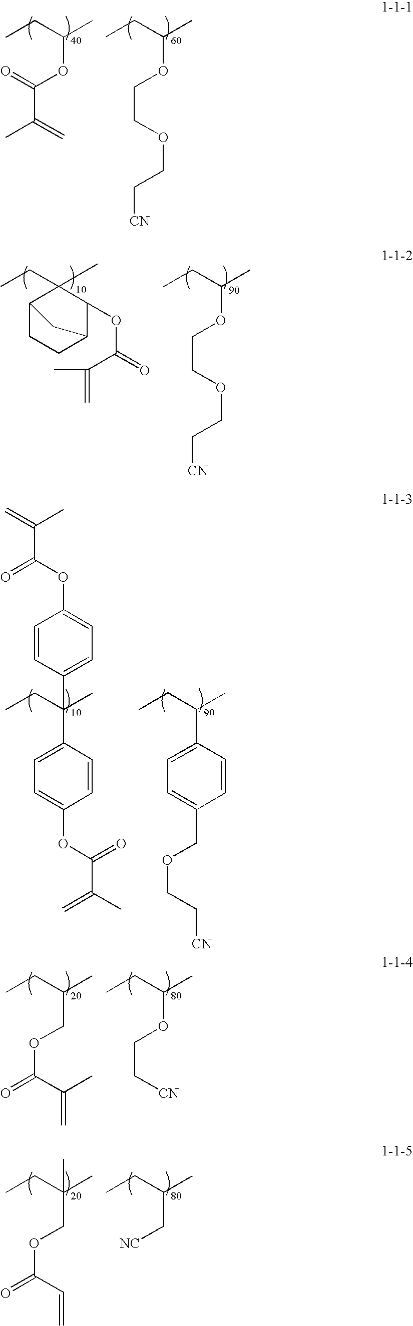

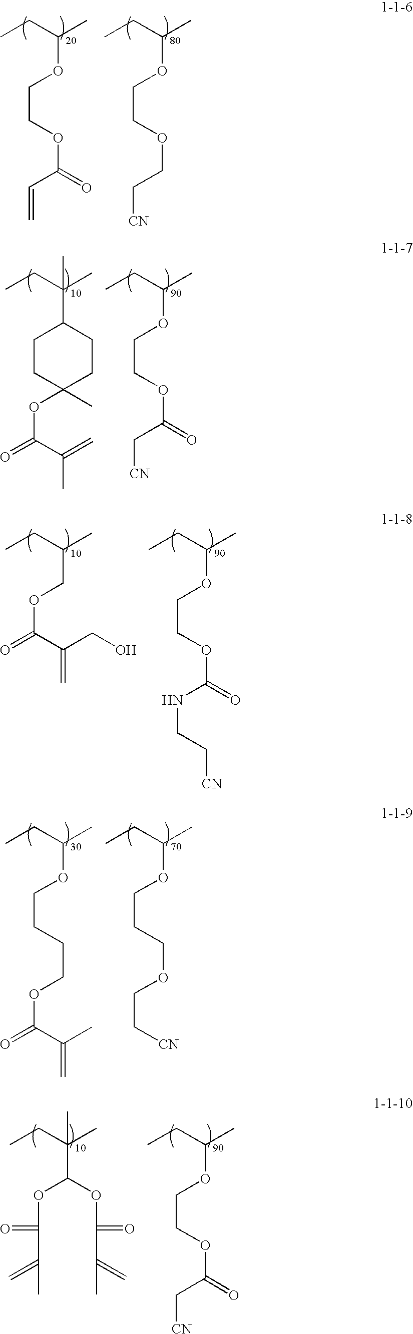

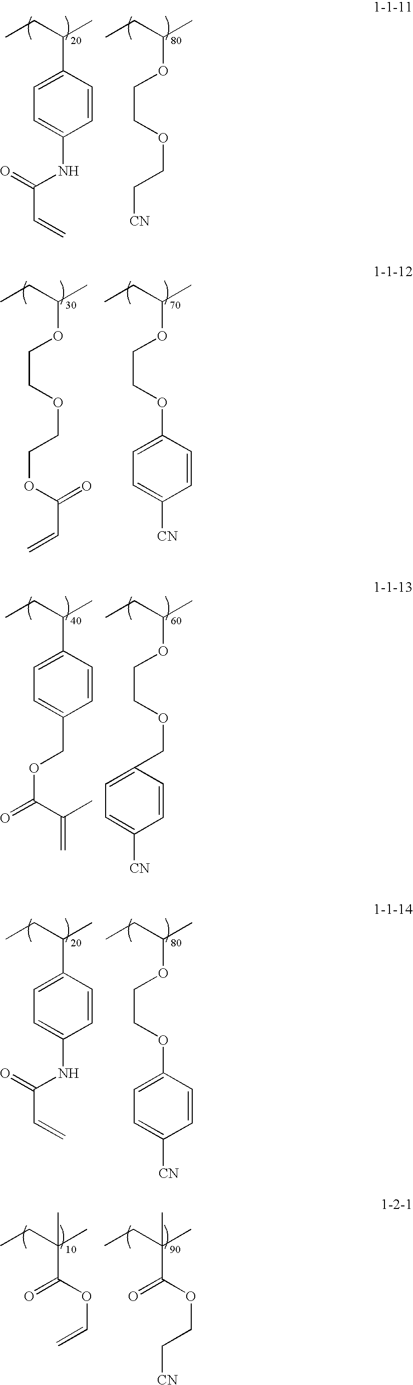

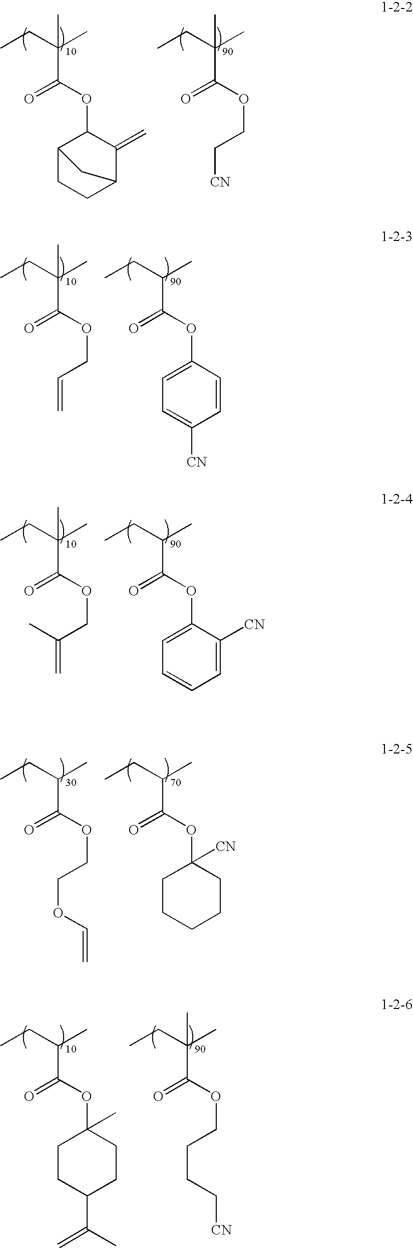

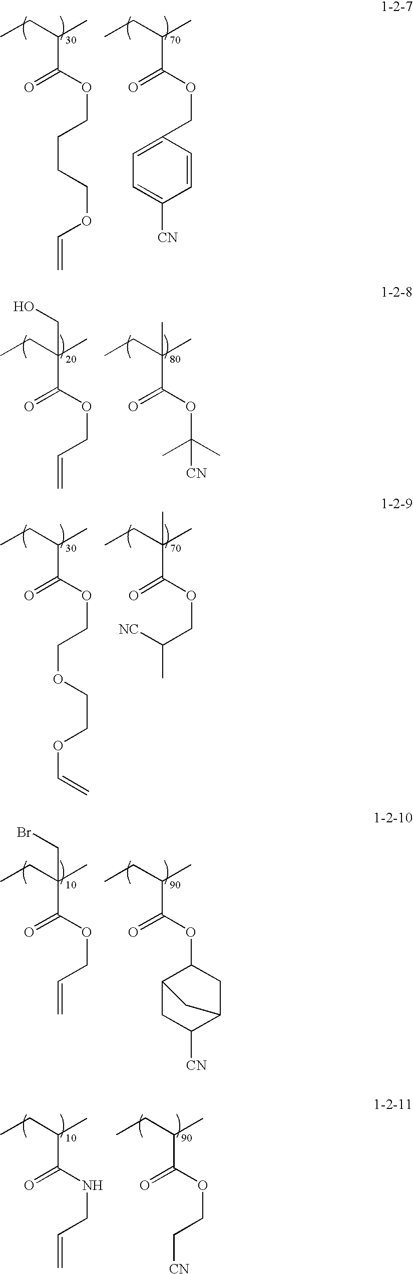

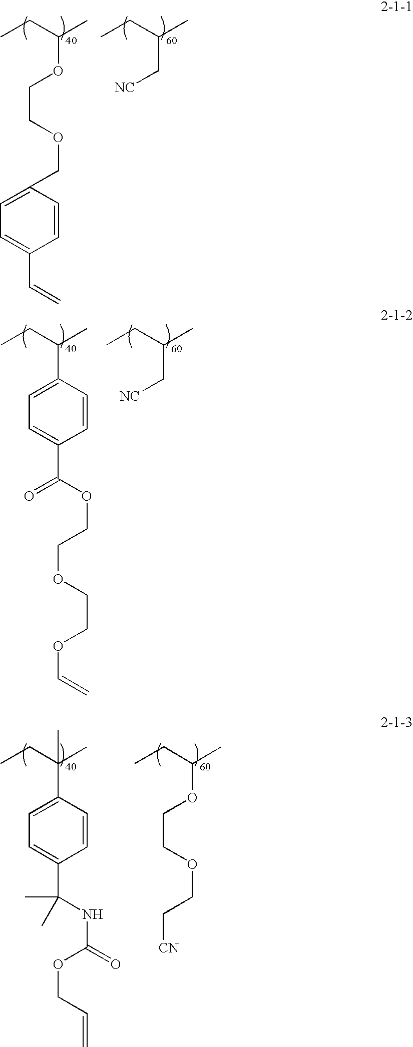

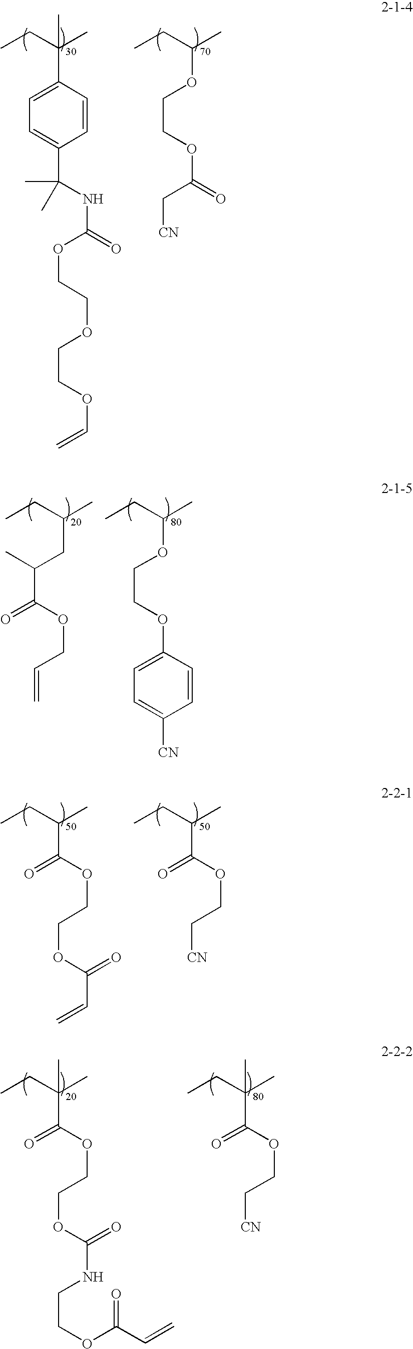

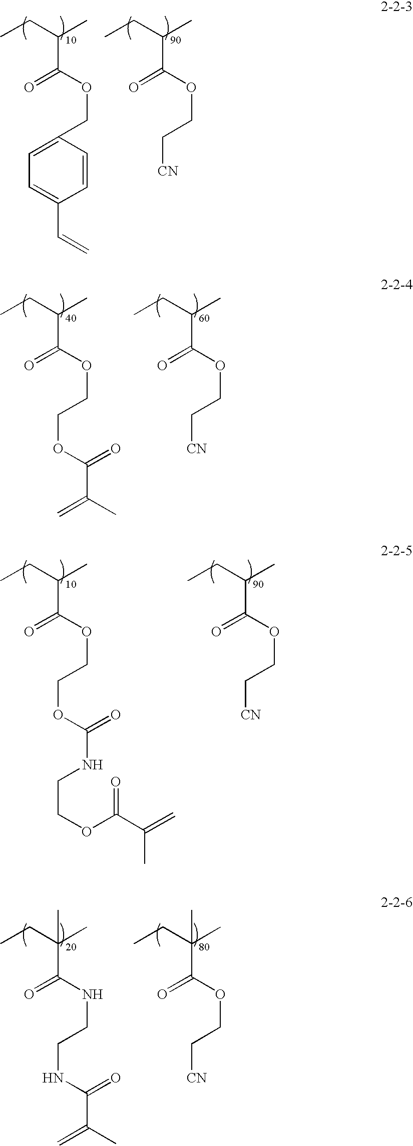

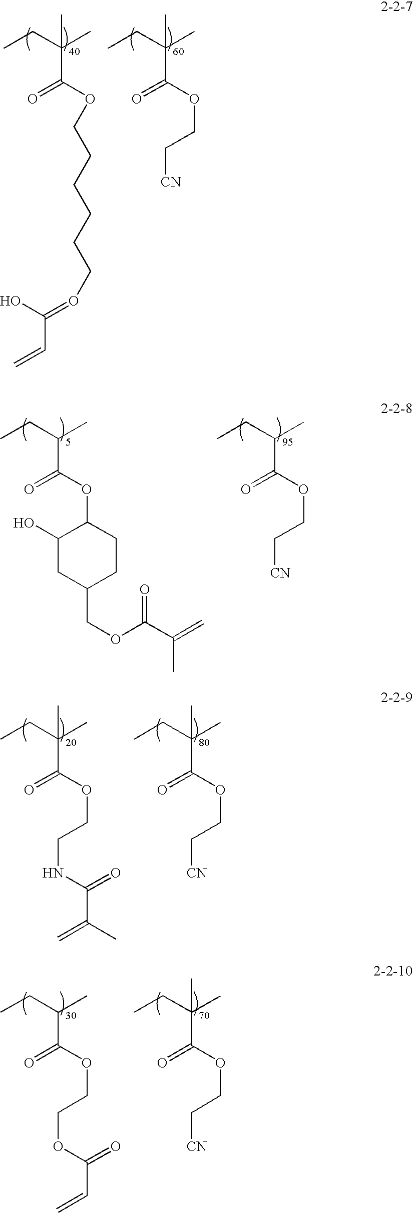

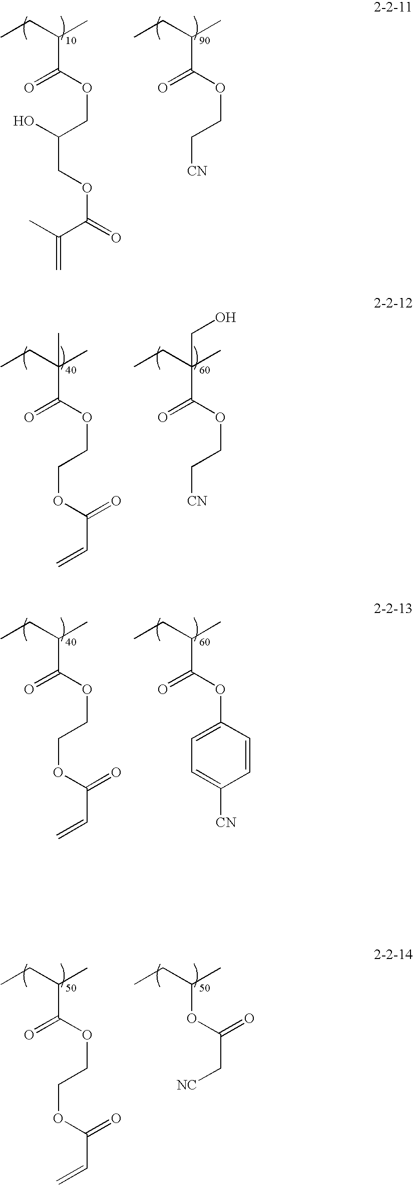

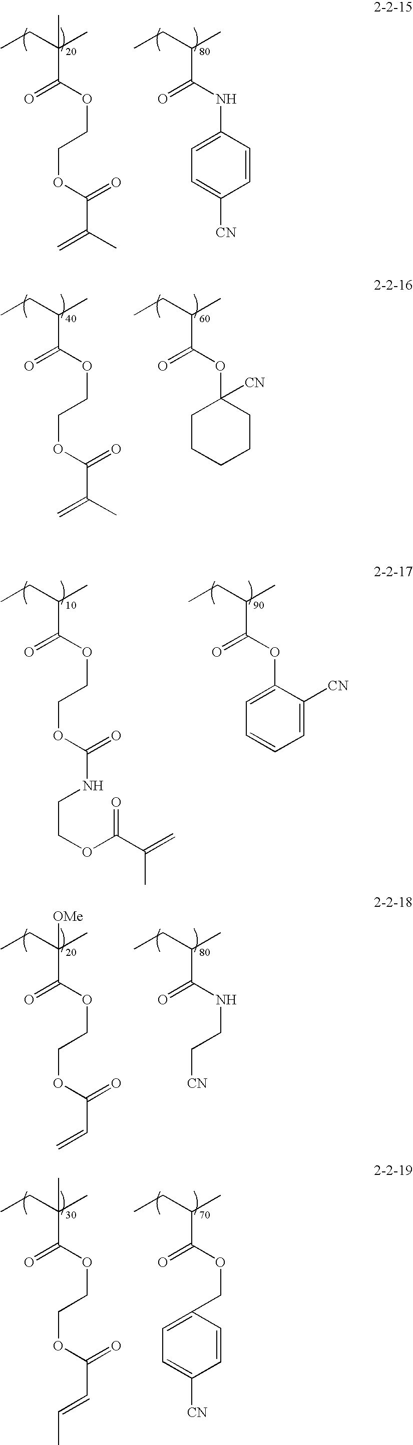

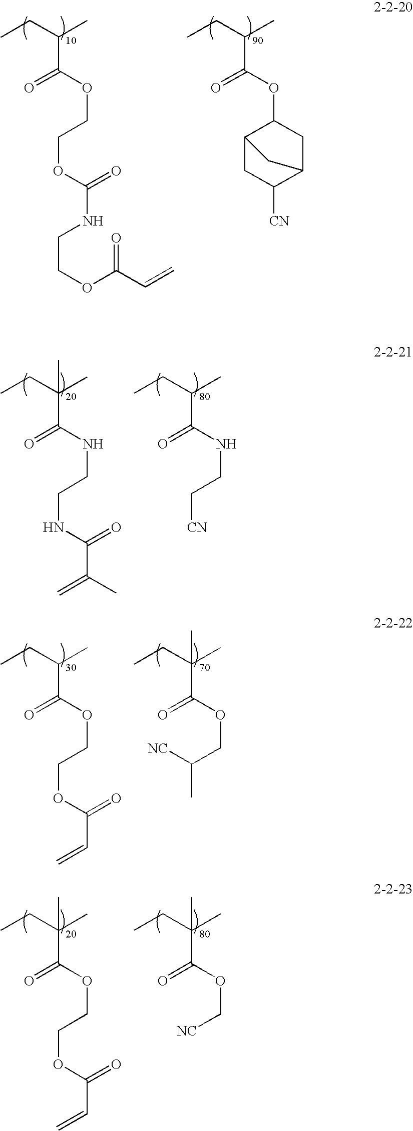

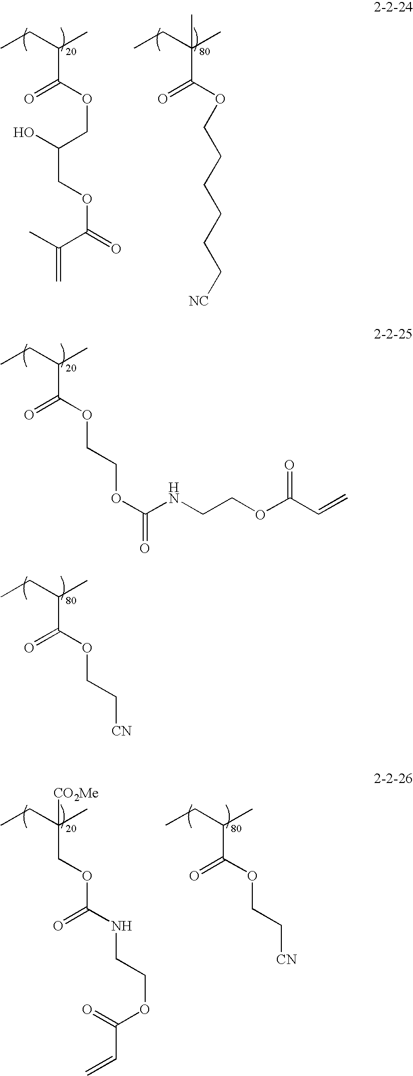

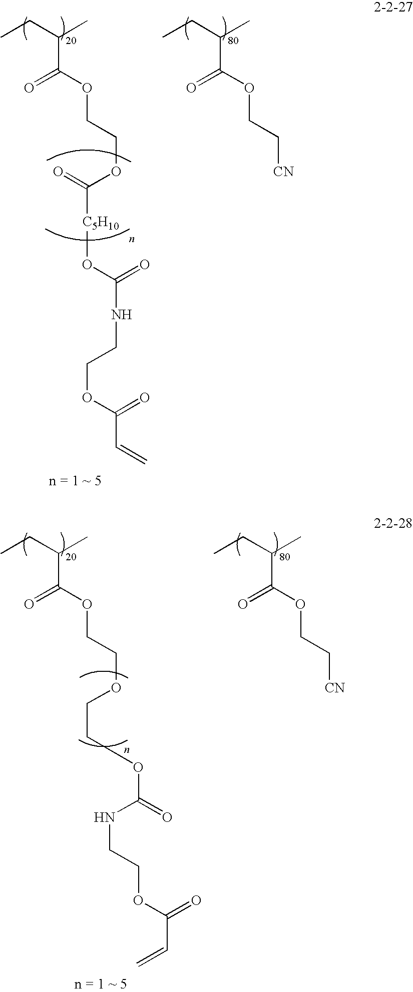

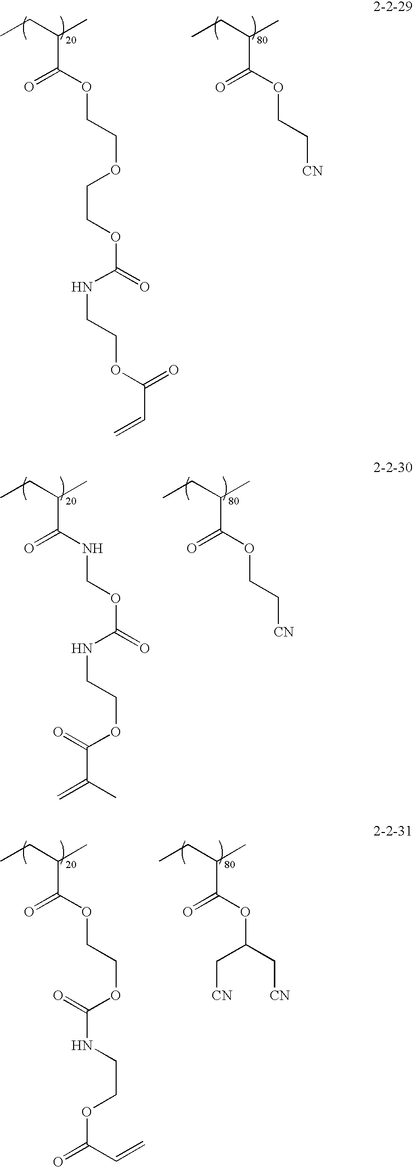

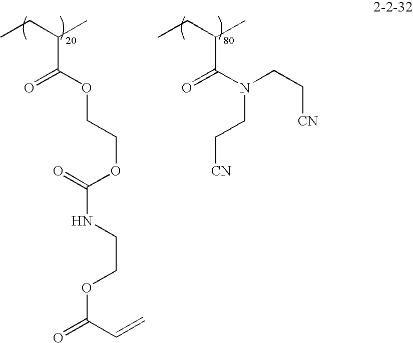

Herein, for instance, a compound 2-2-11 of the specific example is synthesized in such a manner that acrylic acid and 2-cyanoethyl acrylate are dissolved in, for instance, N-methylpyrrolidone, a radical polymerization process is performed with, for instance, azoisobutyronitrile (AIBN) as a polymerization initiator, thereafter, glycidyl methacrylate is subjected to an addition reaction with a catalyst such as benzyltriethylammonium chloride in a state where a polymerization inhibitor such as tertiary butyl hydroquinone is added.

Furthermore, for instance, a compound 2-2-19 of the specific example is synthesized in such a manner that a monomer shown below and p-cyanobenzyl acrylate are dissolved in a solvent such as N,N-dimethyl acrylamide, a radical polymerization process is carried out with a polymerization initiator such as azoisodimethyl butyrate, thereafter a base such as triethylamine is used to dehydrochlorinate.

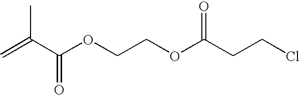

A compound having a cyano group and a polymerizable group such as the cyano group-containing polymerizable polymer in the invention may have, in addition to the polymerizable group and cyano group, a polar group in a range where a formed polymer layer satisfies conditions 1 and 2 described below.

When the compound has a polar group, in the case where after a metal film is formed according to a step described below, for instance, a protective layer is disposed, the adhesive force in a contact region of a polymer layer and a protective layer is improved.

A compound having a cyano group and a polymerizable group in the invention may have, in addition to the polymerizable group and cyano group, a functional group forming an interaction with a plating catalyst or a precursor thereof in a range where a formed polymer layer satisfies conditions 1 and 2 described below.

Specific preferable examples of functional groups include a group capable of forming coordination with a metallic ion, a nitrogen-containing functional group, a sulfur-containing functional group and an oxygen-containing functional group. More specific examples thereof include nitrogen-containing functional group such as an imide group, a pyridine group, a tertiary amino group, an ammonium group, a pyrrolidone group, an amidino group, a triazine ring, a triazole ring, a benzotriazole group, a benzimidazole group, a quinoline group, a pyrimidine group, a pyradine group, a nazoline group, a quinoxaline group, a purine group, a triazine group, a piperidine group, a piperadine group, a pyrrolidine group, a pyrazole group, an aniline group, a group containing an alkylamine group structure, a group containing an isocyanuric structure, a nitro group, a nitroso group, an azo group, a diazo group, an azide group, a cyano group or a cyanate group (R—O—CN); an oxygen-containing functional group such as a phenolic hydroxyl group, a hydroxyl group, a carbonate group, an ether group, a carbonyl group, an ester group, a group containing a N-oxide structure, a group containing a S-oxide structure or a group containing a N-hydroxy structure; a sulfur-containing functional group such as a thiophene group, a thiol group, a thiocyanurate group, a benzothiazole group, a mercaptotriazine group, a thioether group, a thioxy group, a sulfoxide group, a sulfone group, a sulfite group, a group containing a sulfoxyimine structure, a group containing a sulfoxynium salt structure or a group containing a sulfonic acid ester structure; a phosphorus-containing functional group such as a phosphate group, a phosphoroamide group or a phosphine group; a group containing a halogen atom such as chlorine or bromine; and an unsaturated ethylene group. Furthermore, as far as it is an aspect where nondissociative property is exhibited in relation with adjacent atoms or atomic groups, an imidazole group, a urea group or a thiourea group may be used. Furthermore, a structure having formability of complex such as an inclusion compound, cyclodextrin or crown ether may be rendered a functional group forming an interaction with a plating catalyst or a precursor thereof.

Among these, from the viewpoint of higher polarity and higher adsorptivity to the plating catalyst or the precursor thereof, an ether group (more specifically, a structure represented by —O—(CH₂)ₙ—O— (n is an integer from 1 to 5) is preferred.

As mentioned above, in order to form a polymer layer in the invention, a liquid composition containing a compound having a cyano group and a polymerizable group such as a polymer having a cyano group and a polymerizing group, that is, a composition containing a compound having a cyano group and a polymerizable group and a solvent capable of dissolving the compound (preferably a polymer layer-forming composition of the invention, which contains a polymer having a cyano group and a polymerizable group and a solvent capable of dissolving the polymer) is preferably used.

A content in the composition of the compound having the cyano group and the polymerizable group (such as a cyano group-containing polymerizable polymer) is preferably from 2 to 50% by mass to an entirety of the composition.

The solvent to be used for the composition is not particularly limited as long as it can dissolve the compounds having the cyano group and the polymerizable group, which are main components in the composition. The solvent may further be mixed with a surfactant.

Usable solvents are, for example, alcohol type solvents such as methanol, ethanol, propanol, ethylene glycol, glycerin or propylene glycol monomethyl ether; acids such as acetic acid; ketone type solvents such as acetone, methyl ethyl ketone or cyclohexanone; amide type solvents such as formamide, dimethyl acetamide or N-methylpyrrolidone; nitrile tyoe solvents such as acetonitrile or propionitrile; esters such as methyl acetate or ethyl acetate; carbonates such as dimethyl carbonate or diethyl carbonate and the like.

Among above, amide type solvents, ketone type solvents, nitrile tyoe solvents and carbonates are preferable for the compositions comprising the polymerizable polymer having the cyano group. Specific examples of the preferable solvents include acetone, dimethyl acetamide, methyl ethyl ketone, cyclohexanone, acetonitrile, propionitrile and dimethyl carbonate.

The preferable solvent for use in coating of the composition containing the polymerizable polymer having the cyano group includes a solvent having a boiling point of about 50 to 150° C., from the points of easiness in handling. These solvents may be used alone or in combination.

In the invention, when a composition containing a compound having a cyano group and a polymerizable group is coated on a polyimide film, a solvent having the solvent absorption rate of a polyimide film from 5 to 25% may be selected. The solvent absorption rate is determined from a change of mass when a base material forming a polyimide film is dipped in the solvent and pulled up after 1000 min.

Furthermore, when a composition containing a compound having a cyano group and a polymerizable group is coated on a polyimide film, a solvent having the swelling rate of the polyimide film from 10 to 45% may be selected. The swelling rate is determined from a change of a thickness when a base material forming a polyimide film is dipped in the solvent and pulled up after 1000 min.

The surfactant, which is added to the solvent as needed is not particularly limited as long as it is soluble in the solvent, and examples of the surfactants include anionic surfactants such as sodium n-dodecylbenzenesulfonate; cationic surfactants such as n-dodecyltrimethylammonium chloride; nonionic surfactants such as polyoxyethylene nonylphenol ether (commercial product: e.g., Emulgen 910, manufactured by Kao Corporation), polyoxyethylene sorbitan monolaurate (commercial product: e.g., brand name “Tween 20”), and polyoxyethylene laurylether; and the like.

A liquid composition containing a compound having a cyano group and a polymerizable group may contain a polymerization initiator to develop the polymerization initiating ability due to imparted energy.

As the polymerization initiator used herein, a known thermal polymerization initiator or photopolymerization initiator developable the polymerization initiating ability by predetermined energy, for instance, under illumination with an active light beam, heating or illumination with an electron beam may be appropriately selected and used depending on the purpose. Among these, the photopolymerization is used preferably from the viewpoint of production aptitude; accordingly, a photopolymerization initiator is preferably used.

The photopolymerization initiator is not particularly restricted as far as it is active to illuminated active light beam and capable of developing the polymerization initiating ability. For instance, a radical polymerization initiator, an anionic polymerization initiator and a cationic polymerization initiator may be used. Among these, a radical polymerization initiator and a cationic polymerization initiator are preferred and a radical polymerization initiator is more preferred from the viewpoint of handling easiness and reactivity.

Specific examples of such photopolymerization initiators include acetophenones such as p-tert-butyltrichloroacetophenone, 2,2′-diethoxyacetophenone or 2-hydroxy-2-methyl-1-phenylpropane-1-one; ketones such as benzophenone, 4,4′-bisdimethylaminobenzophenone, 2-chlorothioxanthone, 2-methylthioxanthone, 2-ethylthioxanthone or 2-isopropylxanthone; benzoin ethers such as benzoin, benzoin methyl ether, benzoin isopropyl ether or benzoin isobutyl ether; benzyl ketals such as benzyl dimethyl ketal or hydroxycyclohexyl phenyl ketone; sulfonium salts such as triphenyl sulfonium chloride or triphenylsulfonium pentafluorophosphate; or iodonium salts such as diphenyliodonium chloride or diphenyliodonium sulfate.

An addition amount of the polymerization initiator is, to a compound having the cyano group and the polymerizable group in the liquid composition having the compound having the cyano group and the polymerizable group, preferably from 0.1 to 70% by mass and more preferably from 1 to 40% by mass.

Furthermore, a plasticizer may be added as required. Examples of the plasticizers that may be used include general plasticizers such as phthalic acid esters (such as dimethyl ester, diethyl ester, dibutyl ester, di-2-ethylhexyl ester, dinormaloctyl ester, diisononyl ester, dinonyl ester, diisodecyl ester or butyl benzyl ester), adipic acid esters (such as dioctyl ester or diisononyl ester), dioctyl azelate, sebacic acid esters (such as dibutyl ester or dioctyl ester), tricresyl phosphate, acetyl tributyl citrate, epoxidized soy bean oil, trioctyl trimellate, chlorinated paraffin or high boiling temperature solvents such as dimethylacetamide or N-methyl pyrrolidone.

A polymerization inhibitor may be added to the composition containing the compound having the cyano group and polymerizable group, as required. Examples of polymerization inhibitors that may be used include hydroquinones such as hydroquinone, di-tertiary butyl hydroquinone or 2,5-bis(1,1,3,3-tetramethylbutyl)hydroquinone; phenols such as p-methoxy phenol or phenol; benzoquinones; free radicals such as TEMPO (2,2,6,6-tetramethyl-1-piperidinyloxy free radical) or 4-hydroxy TEMPO; phenothiazines; nitrosoamines such as N-nitrosophenyl hydroxylamine or an aluminum salt thereof; and catechols.

Furthermore, as required, a hardening agent and/or a hardening accelerator may be added to the composition containing the compound having the cyano group and polymerizable group to promote curring of a polymer layer.

Examples of the hardening agents and/or hardening accelerators include aliphatic polyamine, alicyclic polyamine, aromatic polyamine, polyamide, acid anhydride, phenol, phenol novolak, polymercaptane and a compound having two or more active hydrogen atoms as a polyaddition type, and aliphatic tertiary amine, aromatic tertiary amine, an imidazole compound and Lewis acid complex as a catalyst type.

Examples of those that start hardening due to heat, light, humidity, pressure, acid or base include diethylenetriamine, triethylenetetramine, tetraethylenepentamine, diethylaminopropylamine, polyamideamine, menthenediamine, isophoronediamine, N-aminoethyl piperadine, 3,9-bis(3-aminopropyl)-2,4,8,10-tetraoxyspiro(5,5)undecane adduct, bis(4-amino-3-methylcyclohexyl)methane, bis(4-aminocyalohexyl)methane, m-xylylenediamine, diaminodiphenyl methane, m-phenylenediamine, diaminophenylsulfone, dicyandiamide, adipic acid dihydrazide, phthalic anhydride, tetrahydro phthalic anhydride, hexahydro phthalic anhydride, methyltetrahydro phthalic anhydride, methylhexahydro phthalic anhydride, methyl nadic anhydride, dodecyl succinic anhydride, chlorendic anhydride, pyromellitic anhydride, benzophenone tetracarboxylic anhydride, ethylene glycol bis(anhydrotrimate), methyl cyclohexene tetra carboxylic anhydride, trimellitic anhydride, polyazelaic anhydride, phenol novolak, xylylene novolak, bis phenol A novolak, triphenylmethane novolak, biphenyl novolak, dicyclopentadienephenyl novolak, terpenephenol novolak, polymercaptan, polysulfide, 2, 4, 6, tris(dimethylaminomethyl) phenol, 2,4,6-tris(dimethylaminomethyl)phenol-tri-2-ethylhexylate, benzyldimethylamine, 2-(dimethylaminomethyl)phenol, 2-methyl-imidazole, 2-ethyl 4-methylimidazole, 2-undecylimidazole, 2-heptadecylimidazole, 2-phenylimidazole, 1-benzyl-2-methylimidazole, 1-cyanoethyl-2-methylimidazole, 2,4-diamino-6-(2-methylimidazolyl-(1))-ethyl-s-triazine, BF₃ monoethylamine complex, Lewis acid complex, organic acid hydrazide, diaminomaleonitrile, melamine derivative, imidazole derivative, polyamine salt, amineimide compound, aromatic diazonium salt, diaryl iodoniumu salt, triaryl sulfonium salt, triaryl selenium salt and ketimine compound.

The hardening agent and/or hardening accelerator is preferably added to an extent from substantially 0 to 50% by mass relative to a remaining non-volatile component obtained by removing a solvent from the viewpoint of the coating property of a solution and the adhesiveness with a substrate and a plating film.

A rubber component (such as CTBN), a fire retardant (such as phosphorus-based fire retardant), a diluent or a thixotropic agent, a pigment, a defoaming agent, a leveling agent or a coupling agent may be further added to the composition containing a compound having a cyano group and a polymerizable group.

When a composition obtained by appropriately mixing the compound having a cyano group and a polymerizable group and the various kinds of additives is used, the physical properties of a formed polymer layer such as the thermal expansion coefficient, the glass transition temperature, the Young's modulus, the Poisson's ratio, the rupture stress, the yielding stress or the thermal decomposition temperature may be set at its best. In particular, the rupture stress, yielding stress and thermal decomposition temperature are preferred to be higher.

The heat resistance of the resulting polymer layer is measured by means of a temperature cycle test, a temporal thermal test or a reflow test.

When the composition containing a compound having a cyano group and a polymerizable group is brought into contact, from the viewpoint of sufficient interaction formability with a plating catalyst or a precursor thereof, a coating amount thereof is preferably from 0.1 to 10 g/m² and particularly preferably from 0.5 to 5 g/m² in terms of the solid content.

When a composition containing a compound having a cyano group and a polymerizable group is coated on a polyimide film and dried to form a layer containing a compound having a cyano group and a polymerizable group, between the coating and drying, a resulting layer may be left at a temperature from 20 to 60° C. for 5 to 2 hr to remove a remaining solvent.

(Energy Application)

The method of applying energy to the polyimide film surface may be carried out by using radiant rays such as heat or light. For example, light irradiation using a UV lamp or visible light rays, and heating by a hot plate are available. The light source to be employed may be, for example, a mercury lamp, a metal halide lamp, a xenon lamp, a chemical lamp, and a carbon arc lamp. Also, g-ray, i-ray, deep UV light and high density energy beam (laser beam) may be used.

As a specific aspect generally used, direct imagewise recording with a thermal recording head, scanning exposure with an infrared laser, high luminosity flush exposure with a xenon discharge lamp and infrared lamp exposure are preferably cited.

A time necessary for imparting energy is usually from 5 sec to 5 hr though different dependent on a generation amount of a target graft polymer and a light source.

When energy is imparted according to the exposure, an exposing power is preferably from 10 to 5000 mJ/cm² and more preferably in the range of 50 to 3000 mJ/cm² to readily forward the graft polymerization and to inhibit a generated graft polymer from decomposing.

Furthermore, when a polymer having an average molecular weight of 20000 or more and the degree of polymerization of 200-mer or more is used as a compound having a cyano group and a polymerizable group, a graft polymerization process is readily forwarded at low energy exposure; accordingly, a generated polymer is further inhibited from decomposing.

According to above-described (a1) step, a polymer layer (graft polymer layer) comprising a graft polymer having a cyano group may be formed on a polyimide film.

When, after the resulting polymer layer is added to an alkaline solution of which pH is 12 and agitated for 1 hr, a polymerizable group portion is decomposed by 50% or less, the polymer layer may be washed with a high alkalinity solution.

In the invention, the polymer layer preferably satisfies conditions 1 and 2 shown below.

Condition 1: The saturated water absorption under an environment of 25° C.-50% relative humidity is from 0.01 to 10% by mass.

Condition 2: The saturated water absorption under an environment of 25° C.-95% relative humidity is from 0.05 to 20% by mass.

The saturated water absorption in the conditions 1 and 2 is measured according to a method described below.

In the beginning, a substrate is left in a reduced pressure dryer to remove moisture contained in the substrate. Thereafter, the substrate is left in a thermostat set at predetermined temperature and humidity, followed by measuring a mass change to measure the saturated water absorption. Herein, the saturated water absorption in the conditions 1 and 2 shows the water absorption when a mass became constant after 24 hr. Separately, also of one in which a polymer layer is formed on a polyimide film of which mass charge is known in advance, the saturated water absorption of a laminate is measured according to a similar operation. Thereby, from the difference of the water absorption of the polyimide film and that of the laminate, the water absorption of the polymer layer may be measured. Furthermore, without imparting the polymer layer on the polyimide film, a single film of a polymer that constitutes a polymer layer is formed by use of a Petri dish and, of a resulting polymer single film, the water absorption thereof may be directly measured according to the above-mentioned method.

Furthermore, in the invention, it is a preferable aspect that a polymer layer obtained in the (a1) step satisfies conditions 1′ and 2′ shown below.

Condition 1′: The saturated water absorption under an environment of 25° C.-50% relative humidity is from 0.01 to 5% by mass.

Condition 2′: The saturated water absorption under an environment of 25° C.-95% relative humidity is from 0.05 to 10% by mass.

Herein, in order to obtain a polymer layer satisfying the conditions 1 and 2 (preferably conditions 1′ and 2′), a method where, as a polymer that constitutes the polymer layer, one low in the water absorption like the above-mentioned polymer having a cyano group or hydrophobic one (low in the hydrophilicity) is used is preferably used from the viewpoint of easiness of control of the water absorption and hydrophobicity. Other than this, a process where a substance that lowers the water absorption or a substance that improves the hydrophobicity is added in a polymer layer or a process where, after a polymer layer is formed, the polymer layer is immersed in a solution that contains a reactive substance that renders a polymer molecule that constitutes the polymer layer hydrophobic to make the polymer and the reactive substance react to render hydrophobic may be used. The processes may be used in combination.

[(a2) Step]

In the (a2) step, a plating catalyst or a precursor thereof is added to the polymer layer formed in the (a1) step. In the step, a cyano group that a polymer constituting a polymer layer has sticks (absorbs) the imparted plating catalyst or precursor thereof corresponding to a function thereof.

Herein, as the plating catalyst or precursor thereof, one that functions as a catalyst of the plating or an electrode in a (a3) plating step described below may be cited. Accordingly, the plating catalyst or the precursor thereof is determined depending on a kind of the plating in the (a3) plating step.

Herein, the plating catalyst or the precursor thereof used in the step is preferably an electroless plating catalyst or a precursor thereof.

(Electroless Plating Catalyst)

As an electroless plating catalyst used in the invention, as far as it may be an active nucleus at the time of the electroless plating, any one may be used. A metal having the catalyst ability of an autocatalytic reduction reaction (those known as a metal that is lower in the ionization tendency than Ni and electroless plated) is cited. Specifically, Pd, Ag, Cu, Ni, Al, Fe and Co are cited. Among these, one that may be rendered multidentate is preferred and Pd is particularly preferred from the number of kinds of coordinatable functional groups and the highness of the catalyst ability.

The electroless plating catalyst may be used as metallic colloid. In general, the metallic colloid is prepared by reducing metallic ions in a solution where a charged surfactant or a charged protective agent (including metal) is present. The charge of the metallic colloid may be controlled by a surfactant or a protecting agent used herein.

<Electroless Plating Catalyst Precursor>

The electroless plating catalyst precursor used in this step is not particularly limited as long as it can become an electroless plating catalyst in a chemical reaction. Metal ion of the 0-valent metal described above as the electroless plating catalyst is commonly used. The electroless plating catalyst precursor, metal ion, is converted in a reduction reaction to the electroless plating catalyst, 0-valent metal. The electroless plating catalyst precursor, metal ion, may be converted to the electroless plating catalyst, 0-valent metal, in a separate reduction step after addition to the polymer layer and before immersion in an electroless plating bath, or alternatively, the electroless plating catalyst precursor may be immersed in an electroless plating bath as it is and converted to the metal (electroless plating catalyst) by a reducing agent present in the electroless plating bath.

Practically, the electroless plating catalyst precursor metal ion is added onto the polymer layer using a metal salt. The metal salt used is not particularly limited as long as it is dissolved in a suitable solvent to afford a metal ion and a base (anion), and examples thereof include M(NO₃)ₙ, MClₙ, M_{2/n}(SO₄), M_{3/n}(PO₄) (M is an n-valent metal atom), and the like. The metal ion, which is preferably used, is formed by dissociation of the above-described metal salt. Specific examples thereof include Ag ion, Cu ion, Al ion, Ni ion, Co ion, Fe ion, Pd ion, and the like. Among them, multidentate ions are preferable, and Pd ion is particularly preferable from the point of the number of functional groups which are capable to form coordinate bond, and catalytic activity.

As one of preferable examples of the electroless plating catalyst or the precursor thereof used in the invention, a palladium compound is cited. The palladium compound serves as a plating catalyst (palladium) or a precursor thereof (palladium ion), which works as an active nucleus at the plating to precipitate a metal. The palladium compound, as far as it contains palladium and works as a nucleus at the time of plating, is not particularly restricted. A palladium (II) salt, a palladium (0) complex and palladium colloid are cited.

Examples of the palladium salts include palladium acetate, palladium chloride, palladium nitrate, palladium bromide, palladium carbonate, palladium sulfate, bis(benzonitrile)dichloropalladium (II), bis(acetonitrile)dichloropalladium (II) and bis(ethylenediamine)palladium (II) chloride. Among these, palladium nitrate, palladium acetate, palladium sulfate and bis(acetonitrile)dichloropalladium (II) are preferred from the viewpoint of the handling easiness and solubility.

Examples of the palladium complexes include tetrakistriphenylphosphine palladium complex and dipalladiumtrisbenzilidene acetone complex are cited.

The palladium colloid is a particle constituted of palladium (0). The magnitude of the particle is not particularly restricted. However, the magnitude thereof is preferably from 5 to 300 nm and more preferably from 10 to 100 nm from the viewpoint of stability in liquid. The palladium colloid may contain another metal as required. As the other metal, for instance, tin is cited. As the palladium colloid, for instance, tin-palladium colloid is cited. The palladium colloid may be synthesized according to a known process or a commercially available one may be used. The palladium colloid may be prepared, for instance, by reducing palladium ions in a solution where a charged surfactant or a charged protective agent is present.

As a process of imparting a metal that is an electroless plating catalyst or a metal salt that is an electroless plating catalyst precursor to a polymer layer, a dispersion where metal is dispersed in an appropriate solvent or a solution that is obtained by dissolving a metal salt in an appropriate solvent and contains dissociated metallic ions is prepared, and, the dispersion or the solution is coated on a polymer layer or a polyimide film on which a polymer layer is formed may well be dipped in the dispersion or the solution.

The dispersion where the metal is dispersed in an appropriate solvent and the solution that is obtained by dissolving a metal salt in an appropriate solvent and contains dissociated metallic ions are appropriately referred to as a plating catalyst solution.

Furthermore, when the surface graft polymerization process is used in the (a1) step, a process where a composition containing a compound having a cyano group and a polymerizable group is brought into contact with a polyimide film and an electroless plating catalyst or a precursor thereof is added in the composition may be used. When a composition containing a compound having a cyano group and a polymerizable group and an electroless plating catalyst or a precursor thereof is brought into contact with a surface of a polyimide film and a surface graft polymerization process is performed, a polymer layer that contains a polymer having a cyano group and chemically bonded directly with the polyimide film and the plating catalyst or the precursor thereof may be formed. When the process is applied, the (a1) and (a2) steps in the invention are carried out in one step.

When, in the (a1) step, a polymer layer has been formed on both sides of a polyimide film, the dipping process is preferably used to bring the electroless plating catalyst or the precursor thereof into contact sequentially or simultaneously with polymer layers on both sides.

When the electroless plating catalyst or the precursor thereof is brought into contact as mentioned above, by making use of an interaction due to intermolecular force such as van der Waal's force or an interaction due to a coordination bond due to a lone electron pair, the electroless plating catalyst or the precursor thereof is absorbed by a cyano group in the polymer layer.

From the viewpoint of allowing sufficiently performing the absorption like this, a metal concentration in a plating catalyst solution (dispersion or solution) or a composition, or a metallic ion concentration in a solution is preferably from 0.001 to 50% by mass and more preferably from 0.005 to 30% by mass.

Furthermore, a contact time of the plating catalyst solution with the polymer layer is preferably substantially from 30 sec to 24 hr and more preferably substantially from 1 min to 1 hr.

When a palladium compound is used as an electroless plating catalyst or the precursor thereof, a content thereof in a plating catalyst solution is preferably from 0.001 to 10% by mass, more preferably from 0.05 to 5% by mass and still more preferably from 0.10 to 1% by mass relative to a total amount of the catalyst solution. In the case where the content is too less, the plating described below is difficult to deposit, and, in the case where the content is excessive, when a metal pattern is formed according to a full additive process described below, the plating is deposited in a place that is not desired or the removability of etching residue is damaged.

Herein, as a solvent that constitutes a plating catalyst solution (dispersion or solution containing an electroless plating catalyst or a precursor thereof), water or a water-soluble organic solvent is preferably used from the viewpoint of the solubility and dispersability of a catalyst metal or a precursor thereof.

More specific examples of water-soluble organic solvents include acetone, dioxane, N-methyl pyrrolidone, methanol, ethanol, isopropyl alcohol, diethylene glycol diethyl ether, diethylene glycol, glycerin, acetonitrile, acetic acid, triethylene glycol monomethyl ether, diethylene glycol dimethyl ether and diethylene glycol diethyl ether.

Furthermore, in the plating solution, a water-insoluble organic solvent may be used as required. Examples of the water-insoluble organic solvents include ester-based solvents such as ethyl acetoacetate, ethylene glycol diacetate, ethyl acetate or propyl acetate; phosphoric acid ester-based solvents: paraffin-based solvents; and aromatic solvents.

When water and a water-soluble organic solvent are used together in a plating catalyst solution used in the invention, the water-soluble organic solvent is used preferably from 0.1 to 40% by mass and more preferably from 5 to 40% by mass relative to a total amount of the plating catalyst solution from the viewpoint of the permeability to the polymer layer.

When such a solvent is used, an appropriate amount of the catalyst may be imparted to the polymer layer.

Furthermore, nitric acid may be added to the plating catalyst solution from the viewpoint of the solubility of the electroless plating catalyst or the precursor thereof.

(Other Catalyst)

In the invention, as a catalyst used to apply the direct electroplating to a polymer layer without applying the electroless plating in a (a3) step described below, a 0-valent metal is used. Examples of the 0-valent metals include Pd, Ag, Cu, Ni, Al, Fe and Co. Among these, one capable of rendering multidentate is preferred and, in particular, Pd, Ag and Cu are preferred from the highness of the absorption (sticking) property to the cyano group and catalyst ability.

By going through the above-described (a2) step, an interaction is formed between the cyano group in the polymer layer and the plating catalyst or the precursor thereof.

[(a3) Step]

In the (a3) step, the plating is applied to the polymer layer to which the electroless plating catalyst or the precursor thereof is imparted to form a plating film. The resulting plating film has excellent conductivity and adhesiveness.

The kind of the plating applied in the step includes the electroless plating and electroplating and may be selected depending on a function of the plating catalyst or the precursor thereof that forms an interaction with the polymer layer in the (a2) step.

That is, in the step, to the polymer layer to which the plating catalyst or the precursor thereof is imparted, the electroplating may be applied or the electroless plating may be applied.

Among these, in the invention, the electroless plating is preferably applied from the viewpoint of an improvement in the formability and adhesiveness of a hybrid structure developed in the polymer layer. Furthermore, it is preferred that, after the electroless plating, the electroplating is further applied to obtain a plating layer having a desired film thickness.

In what follows, the plating preferably applied in the step will be described.

<Electroless Plating>

Electroless plating is an process of depositing a metal in a chemical reaction by using a solution containing the metal ion to be deposited.

The electroless plating in this step is carried out, for example, by washing the polyimide film having an electroless plating catalyst with water to remove an unnecessary electroless plating catalyst (metal) and then immersing it in an electroless plating bath. Any electroless plating bath commonly known in the art may be used as the electroless plating bath.

When the polyimide film having an electroless plating catalyst precursor is immersed in an electroless plating bath while the electroless plating catalyst precursor is adsorbed on or impregnated into the polymer layer, the polyimide film is immersed in an electroless plating bath after washing it with water for removal of unnecessary precursors (metal salt or the like). In this case, reduction of the electroless plating catalyst precursor and the subsequent electroless plating are carried out in the electroless plating bath. Similarly to the above, any electroless plating bath commonly known in the art may be used as the electroless plating bath used here.

The reduction of an electroless plating catalyst precursor may be performed as well as a separate step before the electroless plating with a catalyst activation solution (reducing solution) prepared separately from an aspect where an electroless plating solution such as mentioned above is used. The catalyst activating solution is a solution where a reducing agent capable of reducing an electroless plating catalyst precursor (mainly metallic ion) to a 0-valent metal is dissolved. A concentration of the reducing agent is preferably from 0.1 to 50% by mass and more preferably from 1 to 30% by mass. Examples of the reducing agents include boron-based reducing agents such as hydrogenated sodium boride or dimethylamine-borane, and reducing agents such as formaldehyde or hypophosphorous acid.

Common electroless plating baths have a composition mainly containing 1. a plated metal ion, 2. a reducing agent, and 3. an additive (stabilizer) for stabilization of the metal ion other than solvent. In addition to the above, the plating bath may also contain any known additives such as a stabilizer of the plating solution and the like.

In a solvent used in the plating bath, an organic solvent high in the affinity with a polymer layer low in the water absorption and high in the hydrophobicity (preferably a polymer layer satisfying all of the conditions 1 and 2) may be preferably contained. The selection of the kind and a content of the organic solvent may well be adjusted corresponding to the physical properties of the polymer layer. In particular, as the saturated water absorption in the condition 1 of the polymer layer becomes larger, it is more preferable that the content of the organic solvent is made smaller. Specifically, it goes as shown below.

That is, preferably in the case where the saturated water absorption in the condition 1 is from 0.01 to 0.5% by mass, a content of the organic solvent in a total solvent in the plating bath is preferably from 20 to 80% by mass, in the case where the saturated water absorption is from 0.5 to 5% by mass, the content of the organic solvent in the total solvent in the plating bath is preferably from 10 to 80% by mass, in the case where the saturated water absorption is from 5 to 10% by mass, the content of the organic solvent in the total solvent in the plating bath is preferably from 0 to 60% by mass and in the case where the saturated water absorption is from 10 to 20% by mass, the content of the organic solvent in the total solvent in the plating bath is preferably from 0 to 45% by mass.

The organic solvent used in the plating bath is necessarily water-soluble and, from this point, ketones such as acetone and alcohols such as methanol ethanol and isopropanol are preferably used.

The metals used in the electroless plating bath include copper, tin, lead, nickel, gold, palladium, and rhodium, and among them, copper and gold are particularly preferable from the point of conductivity.

The optimum reducing agent and additives are selected according to the metal. For example, a copper electroless plating bath contains Cu(SO₄)₂ as copper salt, HCOH as reducing agent, a chelating agent such as EDTA and a Rochelle salt (stabilizer for copper ion) and a trialkanolamine as additives. Alternatively, a plating bath used for electroless plating of CoNiP contains cobalt sulfate and nickel sulfate as the metal salts, sodium hypophosphite as reducing agent, and sodium malonate, sodium malate, sodium succinate as complexing agents. Still alternatively, a palladium electroless plating bath contains (Pd(NH₃)₄)Cl₂ as metal ion, NH₃ and H₂NNH₂ as reducing agent, and EDTA as stabilizer. These plating baths may also contain components other than the components above.

The thickness of the plated metal film thus formed by electroless plating can be adjusted by controlling the concentration of the metal salt or ion in plating bath, immersion time in plating bath, or the temperature of plating bath, or the like, and is preferably 0.1 μm or more and more preferably 0.5 μm or more from the point of conductivity.

The immersion time in the plating bath is preferably about 1 minute to 6 hours and more preferably about 1 minute to 3 hours.

A plating film thus obtained by use of the electroless plating is confirmed that an electroless plating catalyst and a plating metal are deposited in the polymer layer and the plating metal is deposited further on the polymer layer according to a section observation due to SEM and an element distribution analysis due to TEM-EDX. Since an interface of a polyimide film and a plating film is in a hybrid state of the polymer and metal, even when an interface of the polyimide film (organic component) and an inorganic material (catalyst metal or plating metal) is smooth (such as 500 nm or less in the difference in the unevenness), the adhesiveness becomes excellent.

<Electroplating>

In the step, when the plating catalyst or the precursor thereof imparted in the (a2) step works as an electrode, the electroplating may be applied to the polymer layer to which the catalyst or the precursor thereof is imparted.

After the electroless plating step above, the metal film formed in the previous step may be further electroplated by using the film as an electrode. This allows easier formation of an additional new metal film with a desirable thickness on the basis of the electroless plated metal film which is superior in adhesiveness to the polyimide film. Thus, the electroplating after the electroless plating, which expands the thickness of the metal film to a desirable value, is advantageous in applying the metal film according to the invention to various applications.

Any hitherto known method may be used as the electroplating method in the invention. Metals used in the electroplating in this step include copper, chromium, lead, nickel, gold, silver, tin, zinc, and the like, and copper, gold, and silver are preferable and copper is more preferable from th

The thickness of the metal film obtained after electroplating varies according to applications and can be controlled by adjusting the concentration of the metal contained in the plating bath, electric current density, or the like. The thickness of the common films used, for example, for electric wiring is preferably 0.5 μm or more and more preferably 3 μm or more from the point of conductivity.

In the invention, when a metal or a metal salt derived from the plating catalyst or plating catalyst precursor and/or a metal deposited in the polymer layer due to the electroless plating are formed in fractal as a fine structure in the layer, the adhesiveness between the metal film and polymer layer is further improved.

When an amount of the metal present in the polymer layer is from 5 to 50% by area in a ratio of the metal occupying in a region from the uppermost surface to a depth of 0.5 μm of the polymer layer and the arithmetic average roughness Ra (JIS B0633-2001) of an interface of the polymer layer and the metal film is from 0.05 to 0.5 μm when a cross section of a polyimide film is photographed with a metallurgical microscope, stronger adhesion is developed.

<Surface Metal Film Material>

By going through the respective steps of a producing process of a surface metal film material of the invention, a surface metal film material of the invention is obtained.

A surface metal film material obtained according to a producing process of the surface metal film material of the invention has an advantage in that, even under a high temperature and high humidity condition, the adhesion of a metallic film is changed less. The surface metal film material may be applied to a variety of applications such as an electromagnetic wave shielding film, a coated film, a two layer CCL (Copper Clad Laminate) material and an electric wiring material.

A producing process of a patterned metal material of the invention includes a step of etching a plating film of the surface metal film material of the invention obtained through the (a1) through (a3) steps in pattern.

The (a4) etching step will be described below.

[(a4) Step]

In the (a4) step, the plating film (metallic film) formed in the (a3) step is etched in pattern. That is, in the step, an unnecessary portion of the plating film formed over an entire surface of the polyimide film is etched and removed to be able to form a desired metal pattern.

Any one of processes may be used to form the metal pattern. However, specifically, a generally known subtractive process or semi-additive process is used.

The subtractive process is a process where a dry film resist layer is disposed on a formed plating film, a pattern same as that of the patterned metal portion is formed via pattern exposure and development, and, with the dry film resist pattern as a mask, the plating film is removed with an etching solution to form a metal pattern. Any one of materials is used as the dry film resist and any of negative type, positive type, liquid and film is used. As an etching process, any one of processes that are used to produce printed wiring boards may be used and dry etching and wet etching may be used, that is, the etching process may be arbitrarily selected. From the work operation point of view, the wet etching is preferred because a unit is simple. As an etching solution, for instance, an aqueous solution of cupric chloride or ferric chloride is preferably used.

Furthermore, the semi-additive process is a process where a dry film resist layer is disposed on the formed electroless plating film, a pattern same as that of a non-patterned metal portion is formed by applying pattern exposure and development, electroplating is applied with a dry film resist pattern as a mask, quick etching is applied to the electroless plating film of the non-patterned metal portion from which the dry film resist pattern was removed to remove the electroless plating film and thereby a metal pattern is formed. As the dry resist film resist and etchant, materials same as that in the subtractive process may be used. Furthermore, as the electroplating method, a method described above may be used.

By going through the (a1) through (a4) steps, a patterned metal material having a desired metal pattern is prepared.

On the other hand, when a polymer layer obtained in the (a1) step is formed in pattern and the patterned polymer layer undergoes the (a2) and (a3) steps, a patterned metal material may be prepared as well (full additive process).

As a process by which the polymer layer obtained in the (a1) step is formed in pattern, specifically, energy imparted when the polymer layer is formed may well be imparted in pattern and a portion where energy is not imparted is developed to remove to form a polymer layer.

The development process is performed by immersing in a solvent capable of dissolving materials used for forming a polymer layer such as a compound having a cyano group and a polymerizing group or by spraying a solvent capable of dissolving materials used for forming a polymer layer such as a compound having a cyano group and a polymerizing group by use of a spray method. The development time is preferably from 1 to 30 min.

The polymer layer formed in the (a1) may be formed in such a manner that the polymer layer is directly patterned by use of a known coating process such as a gravure printing process, an inkjet printing process or a spray coating process with a mask, followed by imparting energy, further followed by developing to form.

The (a2) and (a3) steps for forming a plating film on the patterned polymer layer are the same as that mentioned above.

<Patterned Metal Material>

A patterned metal material of the invention is one obtained according to a producing process of a patterned metal material of the invention.

A polymer layer that constitutes the obtained patterned metal material is low in the water absorption and high in the hydrophobicity as mentioned above; accordingly, an exposed portion of the polymer layer (a region where a metal pattern is not formed) is excellent in the insulation reliability.

The patterned metal material of the invention is preferably one obtained by disposing a metal film (plating film) entirely or locally on a polyimide film of which surface irregularity is 500 nm or less (more preferably 100 nm or less). The adhesiveness between the polyimide film and the patterned metal is preferably 0.2 kN/m or more. That is, the patterned metal material of the invention is characterized in that, while having a smooth polyimide film surface, the adhesiveness between the polyimide film and patterned metal is excellent.

The irregularity of the polyimide film surface is a value obtained by cutting the polyimide film vertically to a surface thereof and by observing the cross section thereof with a SEM.

In more detail, Rz measured based on JIS B 0601, that is, “a difference between an average value of Z data from the largest to the fifth largest summits and an average value of Z data from the smallest to the fifth smallest valleys” is preferably 500 nm or less.

A value of the adhesiveness between the polyimide film and metal film is a value obtained in such a manner that a copper sheet (thickness: 0.1 mm) is bonded to a surface of a metal film (patterned metal) with an epoxy adhesive (trade name: Araldite, manufactured by Ciba Geigy Co., Ltd.), followed by drying at 140° C. for 4 hr, thereafter, a 90° peeling test is carried out based on JIS C 6481, or an edge of the metal film itself is directly peeled and a 90° peeling test is carried out based on JIS C 6481.

A patterned metal material obtained according to a method of manufacturing a patterned metal material of the invention may be applied to various applications such as semiconductor chips, various kinds of electric wiring boards, FPCs, COFs, TABs, antennas, multi-layered wiring boards and mother boards.

### EXAMPLES

In what follows, the invention will be detailed with reference to examples. However, the invention is not restricted thereto. Unless particularly stated, “%” and “parts” are based on mass.

(Synthesis of Polymer A Having Cyano Group and Polymerizable Group)

In the beginning, a polymer A having a cyano group and a polymerizable group is synthesized as shown below.

In a 1000 ml three-neck flask, 35 g of N,N-dimethylacetamide was charged, followed by heating up to 75° C. under nitrogen flow. Thereto, 35 g of N,N-dimethylacetamide solution of 6.60 g of 2-hydroxyethyl acrylate (commercially available product, manufactured by Tokyo Chemical Industry Co., Ltd.), 28.4 g of 2-cyanoethyl acrylate and 0.65 g of V-601 (trade name, manufactured by Wako Pure Chemical Industries, Ltd.) was dropped over 2.5 hr. After the dropping, the solution was heated up to 80° C., followed by agitating for 3 hr. Thereafter, a reaction solution was cooled to a room temperature.

To the reaction solution, 0.29 g of ditertiary butyl hydroquinone, 0.29 g of dibutyltin laurate, 18.56 g of KARENZ AOI (trade name, manufactured by Showa Denko K. K.) and 19 g of N,N-dimethylacetamide were added and allowed reacting at 55° C. for 4 hr. Thereafter, 3.6 g of methanol was added to the reaction solution, followed by reacting further for 1.5 hr. After the reaction came to completion, reprecipitation was performed with ethyl acetate:hexane=1:1 and a solid matter was separated, and thereby 32 g of a polymer A having a cyano group and a polymerizable group (weight average molecular weight: 62000) was obtained.

(Synthesis of Polymer B Having Interactive Group (Hydrophilic Group) and Polymerizable Group)

A polymer B having an interactive group (hydrophilic group) and a polymerizable group was synthesized as shown below.

In a 1000 ml three-neck flask, 15 g of N,N-dimethylacetamide was charged, followed by heating up to 75° C. under nitrogen flow. Thereto, 15 g of a N,N-dimethylacetamide solution of 9.80 g of acrylic acid, and 0.391 g of V-601 (trade name, manufactured by Wako Pure Chemical Industries, Ltd.) was dropped over 2.5 hr. After the dropping, the solution was heated up to 80° C., followed by further agitating for 3 hr. Thereafter, a reaction solution was cooled to a room temperature. To the reaction solution, 40 g of N,N-dimethylacetamide, 0.03 g of ditertiary pentyl hydroquinone, 2.0 g of triethylbenzyl ammonium chloride and 17.06 g of CYCLOMER A (trade name, manufactured by Daicel Chemical Industries, Ltd.) were added and allowed reacting at 100° C. for 2 hr. After the reaction came to completion, reprecipitation was performed with acetonitrile, followed by filtering a solid matter, further followed by washing with acetonitrile and drying, and thereby 8.3 g of a polymer B having an interactive group (hydrophilic group) and a polymerizable group was obtained. The “CYCLOMER A” is one of monomers having a polymerizable group and has an epoxy group.

### Example 1

### [Formation of Polymer Layer]

In the beginning, 10.5 parts by mass of the polymer A having a cyano group and a polymerizable group, 73.3 parts by mass of acetone, 33.9 parts by mass of methanol and 4.8 parts by mass of N,N dimethylacetamide were mixed and agitated to prepare a coating solution A.

As a polyimide film, 125 μm thick KAPTON 500H (trade name, manufactured by Du Pont-Toray Co., Ltd.) was used.

The polyimide film was subjected to ozone treatment with a UV OZONE CLEANER NL-UV42 (trade name, manufactured by NIPPON LASER & ELECTRONICS LAB). The treatment time was 5 sec.

The above-prepared coating solution A was coated on a surface of thus ozone-treated polyimide film by use of a spin coater (rotated at 750 rpm for 20 sec after rotation at 300 rpm for 5 sec), followed by drying at 80° C.

Thereafter, with a UV exposure unit (type No.: UVF-502S, lamp: UXM-501MD, manufactured by San-Ei Electronic Co., Ltd.), at illumination power of 10 mW/cm² (illumination power was measured with a UV integrating actinometer UIT150 with a photoreceptor UVD-S254 (trade name, manufactured by Ushio Inc.)), illumination was applied for 100 sec to expose.

Thereafter, in agitated acetonitrile, a polyimide film on which a polymer layer is formed was immersed for 5 min, followed by washing with distilled water.

At that time, a thickness of a formed polymer layer was 0.6 μm.

(Measurement of Saturated Water Absorption of Polymer Layer)

The saturated water absorption of the obtained polymer layer was measured according to a method described above. Results are as shown below.

Condition 1: saturated water absorption under an environment of 25° C.-50% relative humidity: 1.1% by mass

Condition 2: saturated water absorption under an environment of 25° C.-95% relative humidity: 3.2% by mass

[Addition of Plating Catalyst]

In one obtained by dissolving 0.05% by mass of palladium nitrate (manufactured by Wako Pure Chemical Industries, Ltd.) to acetone, followed by filtrating an undissolved matter with a filter paper to remove, a polyimide film having a polymer layer was immersed for 30 min, followed by washing with acetone for 1 min, further followed by washing with distilled water for 1 min.

[Electroless Plating]

With SURUKAPPU PGT (trade name, manufactured by Uemura & Co., Ltd.), a bath having a bathing condition shown below was used as an electroless plating bath.

TABLE 1

| Solution | Composition of 1 L of |
|---|---|
| preparation order | electroless plating bath |
| 1. Distilled water | Approximately 60 Vol. % |
| 2. PGT-A | 9.0 Vol. % |
| 3. PGT-B | 6.0 Vol. % |
| 4. PGT-C | 3.5 Vol. % |
| 5. Formalin solution * | 2.3 Vol. % |
| 6. Distilled water | Liquid level is adjusted to 1 L |

Formalin solution: formaldehyde solution (special grade) (manufactured by Wako Pure Chemical Industries, Ltd.)

A temperature of an electroless plating bath was controlled to 26° C. and the pH thereof was adjusted to 12.6 with sodium hydroxide and sulfuric acid and with this the electroless plating was performed for 10 min. A thickness of a resulting electroless copper plating film was 0.2 μm.

[Electroplating]

Subsequently, with the electroless copper plating film as a power supply layer and with an electric copper plating bath having a composition below, under a condition of 3 A/dm², electroplating was performed for 30 min. A thickness of the resulted electric copper plating film was 19.5 μm

(Composition of Electroplating Bath)

| | | |
|---|---|---|
| Copper sulfate | 38 | g |
| Sulfuric acid | 95 | g |
| Hydrochloric acid | 1 | mL |
| Copper Gleam PCM (trade name, manufactured by Meltex | 3 | mL |
| Inc.) | | |
| Water | 500 | g |

As mentioned above, a surface metal film material of example 1 was obtained.

(Evaluation of Adhesiveness)

Thus-obtained surface metal film material was subjected to a baking treatment under 100° C.-30 min and 170° C.-1 hr. Thereafter, of a 5 mm wide plating film of the surface metal film material, the 90° peel strength was measured by use of autograph AGS-J (trade name, manufactured by Shimadzu Corporation) at a tension rate of 10 m/min, and found to be 0.77 kN/m.

[Formation of Metal Pattern and Insulation Reliability Test]

An etching resist was formed on a region to be left as a patterned metal (wiring pattern) on a plating film surface of the resulting surface metal film material and a plating film of a region where the resist was not present was removed with an etching solution made of FeCl₃/HCl. Thereafter, the etching resist was removed with an alkali peeling solution made of a 3% NaOH solution, and, thereby a comb-shaped wiring (patterned metal material) for measuring the insulation reliability between lines of line and space=100 μm/100 μm was formed.

When the comb-shaped wiring was left for 200 hr under 125° C.-85% relative humidity (unsaturated), an applied voltage of 10 V and 2 atmospheric pressure by use of a HAST tester (type name: AMI-150S-25, manufactured by ESPEC Corp.), there was found no insulation defect between wirings.

### Example 2

A surface metal film material was prepared in a manner substantially similar to that of example 1, except that, in example 1, the “Addition of Plating Catalyst” and thereafter were changed to methods shown below.

[Addition of Plating Catalyst]

To acetone:water=8:2 (by mass ratio), 0.05% by mass of palladium nitrate (manufactured by Wako Pure Chemicals Industries, Ltd.) was dissolved and an undissolved material was removed with a filter paper. In the solution, a polyimide film having a polymer layer was immersed for 30 min, followed by washing with acetone for 1 min and with distilled water for 1 min.

With the resulted surface metal film material, the adhesiveness test and insulation reliability test were carried out in a manner substantially similar to example 1. As the result, it was found that the 90° peel strength was 0.72 kN/m and the insulation defect between wirings was not observed.

### Example 3

A surface metal film material was prepared in a manner substantially similar to that of example 1, except that, in example 1, the polyimide film was changed from KAPTON 500H (trade name, manufactured by Du Pont-Toray Co., Ltd.) to UPILEX 125S (thickness 125 μm) (trade name, manufactured by Ube Industries. Ltd.).

With the resulted surface metal film material, the adhesiveness test and insulation reliability test were carried out in a manner substantially similar to example 1. As the result, it was found that the 90° peel strength was 0.71 kN/m and the insulation defect between wirings was not observed.

### Example 4

A surface metal film material was prepared in a manner substantially similar to that of example 1, except that, in example 1, the “Addition of Plating Catalyst” and thereafter were changed to methods shown below.

[Addition of Plating Catalyst]

To acetone, 0.5% by mass of palladium nitrate (manufactured by Wako Pure Chemicals Industries, Ltd.) was dissolved and an undissolved material was removed with a filter paper. In the solution, a polyimide film having a polymer layer was immersed for 30 min, followed by washing with acetone for 1 min and with distilled water for 1 min.

With the resulted surface metal film material, the adhesiveness test and insulation reliability test were carried out in a manner substantially similar to example 1. As the result, it was found that the 90° peel strength was 0.75 kN/m and the insulation defect between wirings was not observed.

### Example 5

A surface metal film material was prepared in a manner substantially similar to that of example 1, except that, in example 1, the “Addition of Plating Catalyst” and thereafter were changed to methods shown below.

[Addition of Plating Catalyst]

To 200 parts by mass of a solution obtained by mixing at a mixing ratio of distilled water/nitric acid (special grade/density: 1.38, manufactured by Wako Pure Chemicals Industries, Ltd.)/diethylene glycol diethyl ether (manufactured by Wako Pure Chemicals Industries Ltd.,)=2/1/2, 0.25 parts by weight of palladium acetate (manufactured by Wako Pure Chemicals Industries Ltd.,) was uniformly dissolved. In the solution, a polyimide film having a polymer layer was immersed for 5 min, followed by washing with distilled water for 2 min and with distilled water for 1 min.

With the resulted surface metal film material, the adhesiveness test and insulation reliability test were performed in a manner substantially similar to example 1. As the result, it was found that the 90° peel strength was 0.74 kN/m and the insulation defect between wirings was not observed.

### Example 6

A surface metal film material was prepared in a manner substantially similar to that of example 1, except that, in example 1, the “Formation of Polymer Layer” and thereafter were changed to methods shown below.

[Formation of Polymer Layer]

In the beginning, a polymerization initiator, IRGACURE® 2959 (registered trade name, manufactured by Ciba Specialty Chemicals), was mixed and agitated with 28 parts by mass of an acetone solution of 10% by mass of the polymer A having a cyano group and a polymerizable group so as to be 4% by mass to a solid content of a polymer (polymer A having a cyano group and a polymerizable group) in the acetone solution, thereby, a coating solution B was prepared.

The above-prepared coating solution B was coated on a surface of a polyimide film ozone-treated in a manner substantially similar to example 1 by use of a spin coater (rotated at 750 rpm for 20 sec after rotation at 300 rpm for 5 sec), followed by drying at 80° C.

Thereafter, with a UV exposure unit (type No.: UVF-502S, lamp: UXM-501MD, manufactured by San-Ei Electronic Co., Ltd.), at illumination power of 10 mW/cm² (illumination power was measured with a UV integrating actinometer UIT150 with a photoreceptor UVD-S254 (trade name, manufactured by Ushio Inc.)), illumination was applied for 50 sec to expose.

A washing step was not carried out after the exposure.

Thereby, a polymer layer having a thickness of 0.70 μm was obtained.

(Measurement of Saturated Water Absorption of Polymer Layer)

The saturated water absorption of the obtained polymer layer was measured according to a method described above. Results are as shown below.

Condition 1: saturated water absorption under an environment of 25° C.-50% relative humidity: 1.2% by mass

Condition 2: saturated water absorption under an environment of 25° C.-95% relative humidity: 3.1 % by mass

With the resulted surface metal film material, the adhesiveness test and insulation reliability test were carried out in a manner substantially similar to example 1. As the result, it was found that the 90° peel strength was 0.70 kN/m and the insulation defect between wirings was not observed.

### Reference Example 1

A surface metal film material was prepared in a manner substantially similar to example 1 except that, in the “Formation of Polymer Layer” in Example 1, a polymerization initiation layer was formed on a polyimide film as shown below and the polyimide film with a polymerization initiation layer was used.

[Formation of Polymerization Initiation Layer]

A mixed solution obtained by mixing 11.9 parts by mass of jER806 (trade name, bisphenol F type epoxy resin, manufactured by Japan Epoxy Resin Co., Ltd.), 4.7 parts by mass of LA7052 (trade name: PHENOLITE, curing agent, manufactured by DIC Corporation), 21.7 parts by mass of YP50-35EK (trade name, phenoxy resin, manufactured by Toto Kasei Co., Ltd.), 61.6 parts by mass of cyclohexanone and 0.1 parts by mass of 2-ethyl-4-methylimidazole (hardening accelerator) was filtrated with filter cloth (mesh #200), thereby a coating solution was prepared.

The coating solution was coated on a polyimide film (thickness: 125 μm) made of KAPTONE 500H (trade name, manufactured by Du Pont-Toray Co., Ltd.)by use of a spin coater (rotated at 1500 rpm for 25 sec after rotation at 300 rpm for 5 sec) and dried at 170° C. to cure. A thickness of a cured polymerization initiation layer was 1.3 μm.

With the resulted surface metal film material, the adhesiveness test and insulation reliability test were carried out in a manner substantially similar to example 1. As the result, it was found that the 90° peel strength was 0.79 kN/m and the insulation defect between wirings was not observed.

The polymer layer formation step in reference example 1 necessitates a processing time substantially 10 times the processing times of the polymer layer formation step in examples 1 through 6; accordingly, methods described in examples 1 through 6 are very excellent from the viewpoint of the productivity.

### Comparative Example 1

A surface metal film material was produced in a manner substantially similar to example 1 except that, in the “Formation of Polymer Layer” in example 1, a coating solution A was changed to a coating solution C (coating solution containing a polymer B having an interactive group (hydrophilic group) and a polymerizable group on a polyimide film) prepared as shown below.

That is, 11.7 parts by mass of the polymer B having an interactive group (hydrophilic group) and a polymerizable group, 76.0 parts by mass of isopropanol, 33.9 parts by mass of methanol and 4.81 parts by mass of N,N dimethylacetamide were mixed and agitated, thereby a coating solution C was prepared.

With the resulted surface metal film material, the adhesiveness test and insulation reliability test were carried out in a manner substantially similar to example 1. As the result, it was found that the 90° peel strength was 0.65 kN/m and the insulation defect between wirings was observed in the insulation reliability test.

From this, it is found that the surface metal film material obtained in comparative example 1 is high in the adhesiveness between the plating layer and the polyimide film but low in the insulation reliability between wirings (between patterned metals).

According to the invention, a surface metal film material that is excellent in the adhesiveness of a metal film, reduced variability of the adhesion due to humidity change and excellent heat resistance and flexibility, and a method of manufacturing a surface metal film material, which enables to simply obtain the surface metal film material are provided.

Furthermore, according to the invention, a patterned metal material that is excellent in the insulation reliability of a region where a metal pattern is not formed and excellent in the heat resistance and flexibility, and a method of manufacturing a patterned metal material, which enables to simply obtain the patterned metal material are provided.

Still furthermore, according to the invention, a polymer layer-forming composition capable of forming a polymer layer that is low in the water-absorbing property, high in the hydrophobicity and excellent in the adsorptive property to a plating catalyst or a precursor thereof is provided.

Namely, the present invention provides the following items <1> to <17>.

<1> A method of manufacturing a surface metal film material comprising:

(a1) forming on a polyimide film a polymer layer comprising a polymer that has a cyano group and that chemically bonds directly with the polyimide film;

(a2) imparting a plating catalyst or a precursor thereof to the polymer layer; and

(a3) performing a plating process on the plating catalyst or the precursor thereof.

<2> The method of manufacturing a surface metal film material of the item <1>, wherein the (a1) forming is performed by chemically bonding a polymer having a cyano group and a polymerizable group directly on the polyimide film.

<3> The method of manufacturing a surface metal film material of the item <2>, wherein the polymer having a cyano group and a polymerizable group is a copolymer containing a unit represented by Formula (1) below and a unit represented by Formula (2);

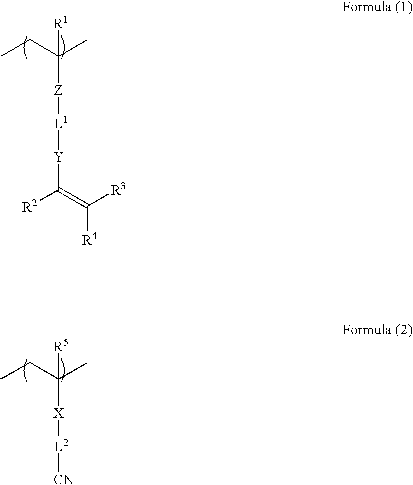

wherein in Formulae (1) and (2), R¹ through R⁵, respectively and independently, represent a hydrogen atom or a substituted or unsubstituted alkyl group, X, Y and Z, respectively and independently, represent a single bond or substituted or unsubstituted divalent organic group, an ester group, an amide group or an ether group, and L¹ and L², respectively and independently, represent a substituted or unsubstituted divalent organic group.

<4> The method of manufacturing a surface metal film material of the item <3>, wherein a structure of L¹ in Formula (1) is a structure represented by Formula (1-1) or Formula (1-2);

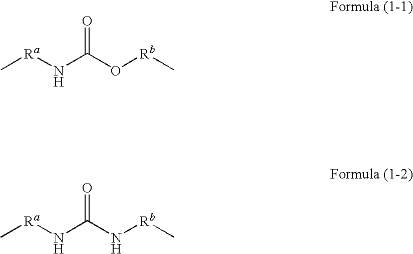

wherein in Formulae (1-1) and (1-2), R^{a} and R^{b}, respectively and independently, represent a divalent organic group having two or more atoms selected from the group consisting of a carbon atom, a hydrogen atom and an oxygen atom.

<5> The method of manufacturing a surface metal film material of the item <3>or <4>, wherein a unit represented by Formula (1) is a unit represented by Formula (3);

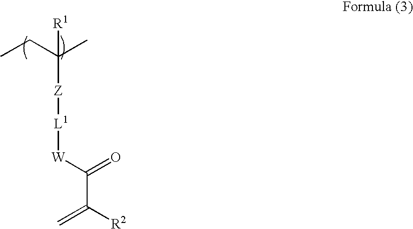

wherein in Formula (3), W represents an oxygen atom or NR (where R represents a hydrogen atom or an alkyl group); R¹ and R² are the same as R¹ and R² in Formula (1); and Z and L¹ are the same as Z and L¹ in Formula (1).

<6> The method of manufacturing a surface metal film material of the item <5>, wherein the unit represented by Formula (3) is a unit represented by Formula (4);

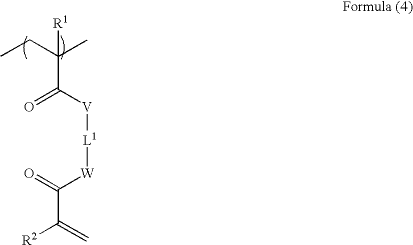

wherein in Formula (4), V represents an oxygen atom or NR (where R represents a hydrogen atom or an alkyl group.), R¹ and R² are the same as R¹ and R² in Formula (3); and Z, W and L¹ are the same as Z, W and L¹ in Formula (3). <7> The method of manufacturing a surface metal film material of any one of the items <3> through <6>, wherein the unit represented by Formula (2) is a unit represented by Formula (5).

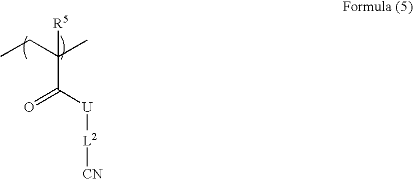

wherein in Formula (5), U represents an oxygen atom or NR′ (where R′ represents a hydrogen atom or an alkyl group); and L² and R⁵ are the same as L² and R⁵ in Formula (2).

<8> The method of manufacturing a surface metal film material of any one of the items <2> through <7>, wherein a weight average molecular weight of the polymer having a cyano group and a polymerizable group is 20000 or more.

<9> The method of manufacturing a surface metal film material of any one of the items <1> through <8>, wherein electroless plating is performed in the (a3) performing a plating process.

<10> The method of manufacturing a surface metal film material of the item <9>, wherein after the electroless plating, a process of electroplating is further performed.

<11> The method of manufacturing a surface metal film material of any one of the items <1> through <10>, wherein the plating catalyst is palladium.

<12> The method of manufacturing a surface metal film material of any one of the items <1> through <11>, wherein the (a1) forming comprises forming a polymer layer comprising a polymer that has a cyano group and that chemically bonds directly with a polyimide film on both sides of the polyimide film.

<13> The method of manufacturing a surface metal film material of the item <12>, wherein the (a1) forming, the (a2) imparting and the (a3) performing of a plating process are performed sequentially or simultaneously on both sides of the resin film.

<14> A surface metal film material obtained by use of the method of manufacturing a surface metal film material of any one of the items <1> through <13>.

<15> A polymer layer-forming composition used in the method of manufacturing a surface metal film material of any one of the items <1> through <13>, comprising:

a polymer having a cyano group and a polymerizable group; and

a solvent capable of dissolving the polymer.

<16> A method of manufacturing a patterned metal material comprising:

(a4) etching a pattern in a plating film of a surface metal film material obtained according to the method of manufacturing a surface metal film material of any one of the items <1> through <13>.

<17> A patterned metal material obtained according to a method of manufacturing a patterned metal material of the item <16>.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. A method of manufacturing a surface metal film material comprising:
forming on a polyimide film a polymer layer comprising a polymer that has a cyano group and that chemically bonds directly with the polyimide film;
imparting a plating catalyst or a precursor thereof to the polymer layer; and
performing a plating process on the plating catalyst or the precursor thereof.

2. The method of manufacturing a surface metal film material of claim 1, wherein the forming is performed by chemically bonding a polymer having a cyano group and a polymerizable group directly on the polyimide film.

3. The method of manufacturing a surface metal film material of claim 2, wherein the polymer having a cyano group and a polymerizable group is a copolymer containing a unit represented by Formula (1) below and a unit represented by Formula (2): 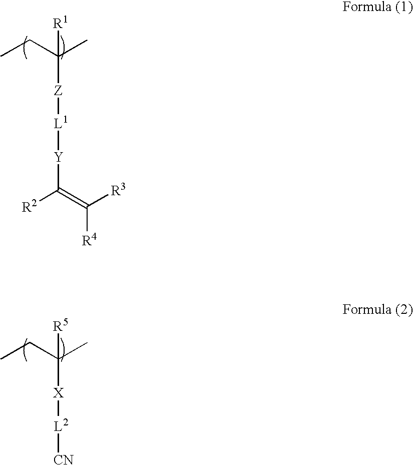
wherein in Formulae (1) and (2), R¹ through R⁵, respectively and independently, represent a hydrogen atom or a substituted or unsubstituted alkyl group; X, Y and Z, respectively and independently, represent a single bond or substituted or unsubstituted divalent organic group, an ester group, an amide group or an ether group; and L¹ and L², respectively and independently, represent a substituted or unsubstituted divalent organic group.

4. The method of manufacturing a surface metal film material of claim 3, wherein a structure of L¹ in Formula (1) is a structure represented by Formula (1-1) or Formula (1-2): 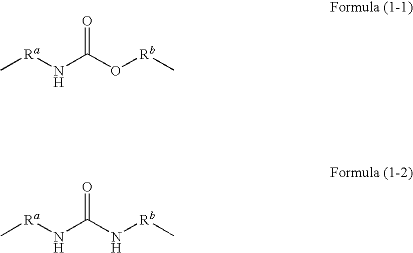
wherein in Formulae (1-1) and (1-2), R^{a} and R^{b}, respectively and independently, represent a divalent organic group having two or more atoms selected from the group consisting of a carbon atom, a hydrogen atom and an oxygen atom.

5. The method of manufacturing a surface metal film material of claim 3, wherein a unit represented by Formula (1) is a unit represented by Formula (3): 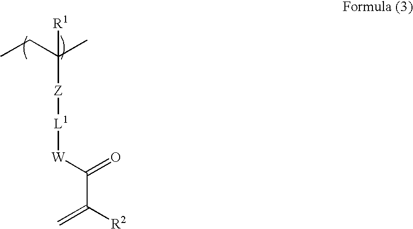
wherein in Formula (3), W represents an oxygen atom or NR (where R represents a hydrogen atom or an alkyl group); R¹ and R² are the same as R¹ and R² in Formula (1); and Z and L¹ are the same as Z and L¹ in Formula (1).

6. The method of manufacturing a surface metal film material of claim 5, wherein the unit represented by Formula (3) is a unit represented by Formula (4): 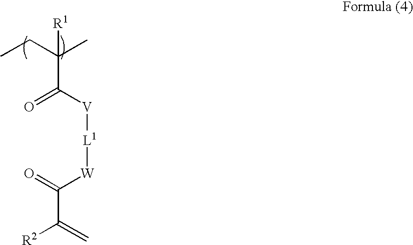
wherein in Formula (4), V represents an oxygen atom or NR (where R represents a hydrogen atom or an alkyl group); R¹ and R² are the same as R¹ and R² in Formula (3); and Z, W and L¹ are the same as Z, W and L¹ in Formula (3).

7. The method of manufacturing a surface metal film material of claim 3, wherein the unit represented by Formula (2) is a unit represented by Formula (5): 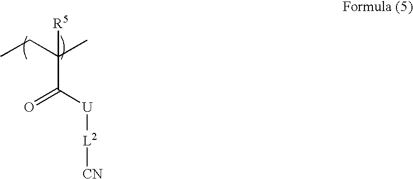
wherein in Formula (5), U represents an oxygen atom or NR′ (where R′ represents a hydrogen atom or an alkyl group); and L² and R⁵ are the same as L² and R⁵ in Formula (2).

8. The method of manufacturing a surface metal film material of claim 2, wherein a weight average molecular weight of the polymer having a cyano group and a polymerizable group is 20,000 or more.

9. The method of manufacturing a surface metal film material of claim 1, wherein electroless plating is performed in the performing of a plating process.

10. The method of manufacturing a surface metal film material of claim 9, wherein after the electroless plating, a process of electroplating is further performed.

11. The method of manufacturing a surface metal film material of claim 1, wherein the plating catalyst is palladium.

12. The method of manufacturing a surface metal film material of claim 1, wherein the forming comprises forming a polymer layer comprising a polymer that has a cyano group and that chemically bonds directly with a polyimide film, on both sides of the polyimide film.

13. The method of manufacturing a surface metal film material of claim 12, wherein the forming, the imparting and the performing of a plating process are performed sequentially or simultaneously on both sides of the resin film.

14. A surface metal film material obtained by use of the method of manufacturing a surface metal film material of claim 1.

15. A polymer layer-forming composition used in the method of manufacturing a surface metal film material of claim 1, comprising:
a polymer having a cyano group and a polymerizable group; and
a solvent capable of dissolving the polymer.

16. A method of manufacturing a patterned metal material comprising:
etching a pattern in a plating film of a surface metal film material obtained according to the method of manufacturing a surface metal film material of claim 1.

17. A patterned metal material obtained according to the method of manufacturing a patterned metal material of claim 16.
